(19) United States
(12) Patent Application Publication
(10) Pub. No.: US 2025/0091627 A1
(43) Pub. Date: Mar. 20, 2025

(54) COLLAPSIBLE CHILDREN'S WAGON AND ASSOCIATED SYSTEM

(71) Applicant: BRITAX CHILD SAFETY, INC., Fort Mill, SC (US)

(72) Inventors: Art GEHR, Fort Mill, SC (US); Brandon HOOVER, Fort Mill, NC (US); Yu Chien HUANG, Fort Mill, SC (US); Yung Shun LIN, Fort Mill, SC (US); Chen Tai CHANG, Fort Mill, SC (US)

(21) Appl. No.: 18/724,090

(22) PCT Filed: Dec. 20, 2022
(86) PCT No.: PCT/US2022/053514

§ 371 Date: Jun. 25, 2024

Related U.S. Application Data
(60) Provisional application No. 63/294,016, filed on Dec. 27, 2021.
(60) Provisional application No. 63/399,087, filed on Aug. 18, 2022.
(60) Provisional application No. 63/315,732, filed on Mar. 2, 2022.
(60) Provisional application No. 63/315,725, filed on Mar. 2, 2022.
(60) Provisional application No. 63/315,722, filed on Mar. 2, 2022.
(60) Provisional application No. 63/315,717, filed on Mar. 2, 2022.

(51) Int. Cl. B62B 3/02; B62B 7/06; B62B 7/14

(52) U.S. Cl. CPC B62B 3/02; B62B 7/06; B62B 7/14; B62B 2205/23

(57) ABSTRACT

A collapsible wagon can include a base frame; a pair of front wheels coupled to the base frame; a pair of rear wheels coupled to the base frame via a suspension system; a handle coupled to the base frame; a lever hingedly connected to the base frame adjacent to a first end of the wagon; a holder frame hingedly connected to the lever adjacent to a second end of the wagon; a seat back hingedly connected to the lever such that when the seat back is opened, the seat back and the lever rotate into a locked relationship; a release mechanism positioned to enable a user to release the seat back from the locked relationship with the lever; and wherein the lever includes a lever foot pedal positioned and arranged for a user to step on the lever foot pedal to hingedly open the lever relative to the base frame.

### CROSS-REFERENCE TO RELATED APPLICATIONS

The instant application claims priority to U.S. Provisional Patent Application No. 63/294,016, entitled “ADJUSTABLE WAGON” and filed Dec. 27, 2021, No. 63/315,717, entitled “CHILDREN'S WAGON INCLUDING MULTI-POSITION HANDLE” and filed Mar. 2, 2022, No. 63/315,722, entitled “CHILDREN'S WAGON INCLUDING RELEASABLY LOCKABLE SEATS” and filed Mar. 2, 2022, No. 63/315,725, entitled “COLLAPSIBLE CHILDREN'S WAGON AND ASSOCIATED SYSTEM” and filed Mar. 2, 2022, No. 63/315,732, entitled “CHILDREN'S WAGON INCLUDING RELEASABLE WHEELS” and filed Mar. 2, 2022, and No. 63/399,087, entitled “CHILDREN'S WAGON WITH REAR SUSPENSION” and filed Aug. 19, 2022, the disclosures of which are hereby incorporated by reference in their entirety.

### BACKGROUND

The present disclosure relates generally to children's wagons.

Children's wagons have existed for over a hundred years. The first Radio Flyer® wagon appears in 1917. Children find great joy in playing with wagons. Wagons allow children to travel with their favorite toys, allowing stuffed animals, dolls and action figures to come along for the ride. Children's wagons also allow parents, who have fond wagon memories of their own, to take place in the action by pulling their children and their friends for a stroll or to a desired location.

Traditional wagons are commonly used for holding and carrying cargo such as children, their toys, beach items (e.g., chairs, towels, and sand buckets/shovels), and sports equipment (e.g., balls, bats, and helmets). Wagons, such as many of the Radio Flyer® wagons, typically include a generally rectangular base and four generally rectangular upright walls forming an open-topped container. The wagons are provided with a pull handle hingedly coupled at the front of the wagon. Four wheels are mounted to the bottom of the base.

While traditional wagons have found commercial success, the wagons also have some drawbacks. The generally rigid metal or wooden wagon can yield a bumpy ride for children, especially over cracked pavement and expansion joints between sidewalk slabs. Traditional wagons may also be cumbersome and heavy to transport and may consume a large amount of an automobile's back seat or trunk.

The handles on traditional wagons in many cases have no good place to be stored during travel. The handle is either rotated to a generally vertical positon, resting against the front base wall or is rotated to the ground in front of the wagon. Neither position is convenient for transporting the wagon or even for storing the wagon after use, e.g., in a garage or other often cluttered location.

Attempts have been made to make children's wagons collapsible but have resulted in inconvenient solutions. U.S. Pat. No. 5,957,482 for example requires the user to remove the wagon's vertical walls so that a base having two hinged halves may be folded together. While the resulting wagon is collapsible, the collapsed position results in multiple loose vertical wall pieces, which may be lost or misplaced by parents and especially children. Moreover, the collapsing of the wagon and the reconstruction of the wagon require multiple manual steps, which are inconvenient and may be difficult to perform.

An improved children's wagon addressing the above-described deficiencies is needed accordingly.

### SUMMARY

The present disclosure sets forth a collapsible children's wagon system and method. The collapsible wagon system includes a collapsible wagon and optional accessories discussed herein. The collapsible wagon in one embodiment includes a base frame, which may include a circumferential tube, e.g., rectangular tube, which essentially defines the footprint of the collapsible wagon. Any rigid part (such as the base frame) and flexible tubing of collapsible wagon may be made (e.g., molded) of any one or more plastic, e.g., polyvinylchloride (“PVC”), polyethylene (“PE”), polyurethane (“PU”), polycarbonate (“PC”) and/or polyetheretherketone (“PEEK”). Any rigid part of collapsible wagon 12 may be made (e.g., machined, formed or cast) alternatively or additionally of any one or more metal, e.g., stainless steel, steel and/or aluminum.

The base frame directly or indirectly supports a front seat bottom and a rear seat bottom. The seat bottoms in one embodiment include hinges that extend upwardly from the seat bottoms and allow front and rear seat backs to connect rotatably to the front and rear seat bottoms, respectively. The seat bottoms and seat backs may be provided with slots that allow safety straps to be fitted though the slots to hold up to three children comfortably in place within the wagon.

The base frame includes or is fitted with lever hinges, which hingedly connect to two sides of a tubular lever. The tubular lever is also circumferential and extends around the entire, or almost the entire, collapsible wagon. The tubular lever is in one embodiment hinged on the front seat side of the base frame and extends around the outside of the rear seat back, so as to be able to rotate towards and away from the rear seat side of the base frame.

A curtain holder frame is hingedly connected at two places to the rear seat side of the tubular lever. The curtain holder frame may be tubular and generally U-shaped so as to extend around the outside of the front seat back, and so as to be able to rotate towards and away from the front seat side of the tubular lever. A collapsible fabric curtain or wall is attached in one embodiment around the U-shaped curtain holder frame so as to provide collapsible front and side walls. The same curtain or collapsible wall or a separate collapsible fabric curtain or wall may be attached to the rear seat end of the tubular lever to provide a collapsible rear wall of the wagon.

The base frame, tubular lever and curtain holder frame are hingedly attached so as to provide an accordion type structure that can be expanded to open the wagon to an opened or operating position and to collapse the wagon to a collapsed position. In an embodiment, the front seat back is hingedly connected to the front seat side of the curtain holder frame, while the rear seat back is hingedly connected to the rear seat side of the tubular lever. The movement of the curtain holder frame and the tubular lever is accordingly mechanically linked to the movement of the front and rear seat backs in one embodiment.

The front and rear seat backs are each provided in one embodiment with release mechanisms, which may be sliding release mechanisms, which the user actuates or slides to enable the front and rear seat backs to be folded down onto respective front and rear seat bottoms. In an embodiment, the collapsible wagon is configured such that the user does not have to actuate the front and rear seat release mechanisms to rotate the front and rear seat backs up from the front and rear seat bottoms, respectively, but when rotated fully upward, the front and rear seat backs become locked in place and cannot be rotated back down onto the front and rear seat bottoms without actuation of the release mechanism.

The front and rear seat release mechanisms are configured and operate in the same manner in one embodiment, the consistency of which is advantageous to the user. The front and rear seat release mechanisms in one embodiment include a slidable button that slides within an elongated notch located at the top of the front and rear seat backs. A tab extends down from the slidable button in one implementation, wherein one or more spring is provided to push against the tab and bias the slidable button towards a center of notch, allowing the user to slide the button in either direction to actuate front and rear seat release mechanisms, releasing the front and rear seat backs to be rotated to a collapsed or stowed position. When the slidable button is not actuated and is centered by the one or more spring, the tab blocks the user from moving a handle to release the front and rear seat backs for collapsing same onto their respective seat bottoms.

The tab of the slidable button is aligned with and may abut a like tab extending up from the handle, which may be formed with or attached to a member that is held releasably within a catch when the seat backs are locked in their upright positions. The catch for securing the front seat back member is provided by the curtain holder frame in one embodiment, so that when the front seat back member is located within the catch of the curtain holder frame, the hinges connecting the front seat back to the curtain holder frame are locked and neither the front seat back or the curtain holder frame can be rotated or collapsed. Similarly, the catch for securing the rear seat back member is provided by the tubular lever in one embodiment, so that when the rear seat back member is located within the catch of the tubular lever, the hinges connecting the rear seat back to the tubular lever are locked and neither the rear seat back or the tubular lever can be rotated or collapsed.

The one or more spring of the front and rear seat release mechanisms is/are biased so as to maintain the front and rear seat back members within their respective catches. When the user slides one of the slidable buttons, the button slides its associated tab so that it is no longer in registry with, and no longer blocks, the tab extending up from the handle of the front or rear seat release mechanism. The user is then able (with the slidable button still actuated) to grasp and pull up the handle, which may be located on the backside of the front or rear seat back, which in turn pulls the member out from the associated catch. When the member is pulled from the catch, the hinges connecting the seat back to the curtain holder frame or the tubular lever become unlocked, allowing the user to rotate and collapse the seat back onto its respective seat bottom.

The collapsible wagon may be sized such that the front or rear seat back rotates down and folds onto the other rear or front seat back. Here, there is a preferred order in collapsing the seat backs where the seat back that rotates and folds onto the other seat back is collapsed second. The collapsible wagon is sized alternatively such that the front and rear seat backs do not interfere with one another when rotated down and folded onto their respective seat bottoms. Here, the front and rear seat backs may be collapsed in either order.

The collapsible wagon of the present disclosure also includes a handle with which to pull or otherwise move the wagon. As used herein, the term “handle” may include the entire handle mechanism extending from the base frame to a handle grip, which is grasped and maneuvered by the user. The handle may include a handle extension, which may be molded or machined and be bolted or welded to the base frame. The handle extension extends to a handle pivot. The length of the handle extension is selected so that the pivot is located elevationally above the front and rear seat backs when the backs are rotated and collapsed onto their respective seat bottoms.

A handle shaft extends from the handle pivot to the handle grip, e.g., an enclosed or circular handle grip. The length of the handle shaft is selected so that the overall handle extends a desired distance from the base frame. An outer portion of the handle grip is grasped and pulled or pushed by the user to move the collapsible wagon. An inner portion of the handle grip includes a latch, which is part of a handle release mechanism. The latch is in one embodiment pivotally connected within a notch formed in the inner portion of the handle grip. The handle release mechanism enables the handle shaft and the handle grip to be locked in one of a plurality of rotational positions until the user desires to change the rotational position of the handle shaft.

The handle release mechanism includes one or more cable or wire that extends from the pivoting latch, through handle shaft, to a translatable locking member where the one or more cable or wire is attached. The translating locking member is part of a rotating portion of the handle pivot. In one embodiment, the rotating portion of the handle pivot is located within an outer non-rotating portion of the handle pivot, which may be formed with or attached to the handle extension. The non-rotating portion of the handle pivot may include housing covers that hide a bracket, wherein the bracket includes a bottom wall and two end walls extending from the bottom wall. The end walls have the same shape. Each end wall in an embodiment has an upper generally circular shape. Notches are formed in the circular shapes of the end walls, which define the different positions at which the handle shaft may be locked in place. Three notches defining three different locked positions are provided in one embodiment, however, any desired number of locked positions may be defined using the notches of the present disclosure.

In one embodiment, the three different locked positions include a stowed position, which is used when the collapsible wagon is collapsed or in its stowed position. A second position is an intermediate upright position to which the user may conveniently bring the handle shaft and handle grip when expanding the wagon from the collapsed position to the operable position. A third position defines a limit that the handle shaft and handle grip may rotate away from the rest of the wagon while the user is pushing or pulling the wagon. In one implementation, the notches for the stowed and upright positions are three-sided, such that the handle shaft and handle grip are constrained from moving in either direction in those positions. The third position on the other hand may only have a two-sided notch, which constrains the handle shaft and handle grip when reaching the end of travel during pulling and pushing, but which allows the user to adjust the handle shaft and handle grip between the upright position and the end of travel position as desired and at any time while pulling or pushing the wagon.

The translatable locking member in one embodiment includes a cylindrical portion that extends through a rotating hub of the rotating portion of the handle pivot. The translatable locking member also includes a bar that extends through or from the cylindrical portion of the translatable locking member. The bar and the cylindrical portion of translatable locking member in one embodiment form a T-shaped structure. The bar can be polygonal, such as square or rectangular, in cross-sectional shape. However, it should be noted that the bar may have any cross-sectional shape, such as an elliptical cross section, D-shaped cross section, and/or double D-shaped cross section, as appropriate to the requirements of specific applications of embodiments of the invention. In an embodiment, the cross-sectional shape of the bar mates with the shape of the notches formed in the top portion of each end wall of the bracket. The bar engages one of the plural notches of each end wall of the bracket to either releasably lock the handle shaft and the handle grip in a desired position, e.g., upright or stowed, or to catch the handle shaft and the handle grip at an end of travel for pulling or pushing the collapsible wagon of the present disclosure.

The bottom wall of the bracket in one embodiment defines an opening that is large enough to accept the bottom of the cylindrical portion of the translatable locking member. The opening can be circular and/or any other shape as appropriate to the requirements of specific applications of embodiments of the invention. When the handle shaft and handle grip are rotated to the second or intermediate upright position, the shaft and handle are perpendicular to the bottom wall of the bracket. Additional room is needed to accept the length of travel of the cylindrical portion of the translatable locking member. The opening in the bottom wall of the bracket provides such additional room, allowing the bottom of the cylindrical portion to extend through the bottom wall.

The handle release mechanism also includes a spring, e.g., a torsion spring, biased to maintain the bar in an engaged or locked position in one of the plural notches of each end wall of the bracket. The spring is in one embodiment positioned and biased so as to maintain the pivotally connected latch rotated down against the notch formed in the inner portion of the handle grip. When the user grasps and pulls the, e.g., pivotally connected, latch, the action works against the spring and causes the one or more cable or wire to be pulled, which in turn pulls the translatable locking member including the perpendicularly disposed bar, such that the bar is removed from the currently engaged notch of each end wall of the bracket. The user is then able to rotate the handle shaft and the handle grip about the handle pivot, such rotation being relative to the handle extension, to a desired new locked position. For example, the user can rotate the handle shaft and the handle grip in the same direction from the stowed position to the upright position or to the end of travel position. The user can rotate the handle shaft and the handle grip in either direction from the upright position to the stowed position or to the end of travel position. Or, the user can rotate the handle shaft and the handle grip from the end of travel position to the upright position.

As soon as the bar is removed from the currently engaged notch of each end wall of the bracket, the user can let go of the spring-loaded latch. When the bar of the rotatable and translatable locking member reaches a new set of notches, the biasing of the spring, which may be aided by gravity, causes the bar to move into the new set of notches and the pivotally connected latch to collapse against the notch formed in the inner portion of the handle grip.

To rotate the handle shaft and the handle grip to the stowed or collapsed position, the front and rear seat backs first need to be rotated onto their respective front and rear seat bottoms so as to make room for the handle shaft and the handle grip. The user slides the slidable buttons at the top of the front and rear seat backs to rotate the seat backs onto the seat bottoms as discussed herein. Because the front seat back is hingedly connected to the curtain holder frame and the rear seat back is hingedly connected to the tubular lever, the folding down or collapsing of the front and rear seat backs also causes the accordion type relationship between the curtain holder frame and the tubular lever to collapse. The collapsible wagon accordingly reaches a stowed or collapsed position. The user may now pull the latch of the handle release mechanism and rotate the handle shaft and the handle grip onto the top of the folded-down or collapsed seat backs.

To change the collapsible wagon from the collapsed position to the opened or operating position, the user first pulls the latch of the handle release mechanism and rotates the handle shaft and the handle grip from the top of the folded-down or collapsed seat backs to the upright position. The user can step on a lever foot pedal formed with or connected to the tubular lever. The user's stepping force causes the tubular lever to rotate about the lever hinges fitted to or formed with the base frame. The hinged connection between the rear seat back and the tubular lever causes the rear seat back to simultaneously rotate up from the rear seat bottom. In many embodiments, the user can raise the rear seat directly. Activation of the slidable button on the top of the rear seat back is not needed to rotate the rear seat back upwardly, however, the rear seat back's reaching of the fully opened position causes the rear seat back to be locked in the open position, which requires activation of the slidable button to again collapse the rear set back. With the rear seat back opened, the user then grabs the front seat back and rotates it upward to the open position. Similarly, activation of the slidable button on the top of the front seat back is not needed to rotate the front seat back upwardly, however, the front seat back's reaching of the fully opened position causes the front seat back to be locked in the open position, which requires activation of the slidable button to again collapse the front set back.

The collapsible wagon system of the present disclosure is provided with a canopy option. It is contemplated for the wagon system to connect the canopy in a plurality of different ways. In any case, front and rear canopy holders are provided, which may be bent metal or formed plastic tubing forming U-shapes. The canopy, e.g., cloth, is held on either end by the middle of the U-shapes of the front and rear canopy holders. The ends of the U-shapes of the front and rear canopy holders connect respectively to the front and rear seat backs (no hinging) or to the curtain holder frame (hinged connection). In one embodiment, the ends of the U-shapes of the front and rear canopy holders connect respectively to the front and rear seat backs in a non-hinged manner. Here, the canopy holders ride with the front and rear seat backs in changing from the opened or operating position to the stowed or collapsed position and vice versa. In an alternative embodiment, the ends of the U-shapes of the front and rear canopy holders connect respectively to the curtain holder frame in a hinged manner. The canopy hinges may include detents that maintain the canopy holders in their upright positions. The force provided by the detents is relatively easily overcome by the user to fold down or collapse the canopy holders. When collapsing the collapsible wagon of the present disclosure, the collapsing or folding down of the canopy holders occurs immediately prior to the folding down or collapsing of the corresponding seat back. When opening the collapsible wagon for operation, the opening of the canopy holders occurs immediately after the opening of the corresponding seat back.

In an embodiment, the front and rear wheels of the collapsible wagon of the present disclosure are removable for replacement, cleaning, repair, etc. The rear wheels in an embodiment are removed laterally or sideways with respect to the wagon, while the front wheels are removed downwardly with respect to the wagon. Regarding the rear wheels, the wheels are each fixedly connected to a rotating shaft. The rotating shaft fits inside of a tube that extends to both rear wheels and is held fixed by the base frame. The end of the rotating shaft that fits inside of the tube defines an annular groove extending all the way around the rotating shaft. The end of the rotating shaft residing directly adjacent to the annular groove is beveled to aid in the reinsertion of the rear wheel and the rotating shaft into the tube.

The tube defines a slot, which may extend radially along the tube for, e.g., 20° to 50°. A user pressable tab is provided, which has an O-shaped portion that fits around the tube. The O-shaped portion includes or defines a projection that extends through the slot defined by the tube. A spring is located between the tube and the opposite end of the O-shaped portion from the projection. The spring is biased to push the tab relative to the tube such that the projection is forced through the slot in the tube, and so that the end of the projection becomes inserted into the annular groove defined by the rotating shaft, which holds the rear wheel within the tube and rotatably fixed with respect to the rest of the collapsible wagon. The annular nature of groove of the rotating shaft dictates that the end of the projection remains within the groove regardless of the rotational position of the rear wheel and the rotating shaft relative to the tube.

The tab also includes an actuation portion located adjacent to the O-shaped portion. The actuation portion extends through a slot defined in a cover having an opening through which the tube extends. A distal end of the actuation portion of the tab extends out from the slot in the cover. The distal end is viewable and accessible by the user. When the user desires to disengage one of the rear wheels from the collapsible wagon, the user presses the distal end of the actuation portion of the tab, translating the O-shaped portion of the tab, which compresses the spring located between the O-shaped portion and the tube. Translating the O-shaped portion of the tab also causes the projection to momentarily come free from the annular groove of the rotating shaft, which allows the user to pull the rear wheel and the rotating shaft from the tube and the remainder of the collapsible wagon.

After the wheel and the rotating shaft are removed and the user releases the distal end of the actuation portion of the tab, the spring is also released so that it pushes the projection of the O-shaped portion of the tab back to the annular groove locking position, e.g., even further than the locking position, even though the rotating shaft defining the annular groove has been removed. As mentioned above, the end of the rotating shaft residing directly adjacent to the annular groove is beveled to aid in the reinsertion of the rear wheel and the rotating shaft into the tube. Upon reinsertion of the rear wheel (or new rear wheel) and associated rotating shaft, the angled surface of the beveled end contacts the projection of the O-shaped portion of the tab, pushing the projection outwardly along the angled surface, guiding the tab towards the annular groove. Eventually, the projection reaches the end of the angled surface and moves along the constant diameter of the rotating shaft until snap-fitting into the annular groove. At that point, the rear wheel is again rotatably attached to the remainder of the collapsible wagon.

Disconnection and reconnection of the front wheels from and to the collapsible wagon involves the same or similar spring-loaded tab including a projection that fits into an annular groove of a rotating shaft. The rotating shafts of the front wheels are different than the rotating shafts of the rear wheels. In one embodiment, the rear wheels do not swivel for steering the wagon, while the front wheels do swivel. The rotating shaft of the front wheels is in one embodiment the shaft allowing the front wheels to swivel, which extends generally upwardly instead of the horizontally extending rotating shafts of the rear wheels.

The upwardly extending rotating swivel shafts of the front wheels extend into circular mounts, which are in one embodiment formed with or fastened to a bottom side of the front seat bottom. The user pressable tabs again include O-shaped portions that instead of fitting around a tube for the rear wheels, fit around the rotating shafts. Another difference is that the O-shaped portion of the tabs for the front wheels does not include or define a projection that extends into the annular groove. Instead, an inner edge of the O-shaped portion extends into the annular groove. A further difference is that the spring is not located within the O-shaped portion as with the rear wheels and is instead located outside the O-shaped portion of the tab. The spring for each front wheel extends between the outside of the O-shaped portion of the tab and a plate that extends along a front of the base frame, from front wheel to front wheel. The spring is biased to push the tab relative to the rotating shaft such that the inner edge of the O-shaped portion extends into the annular groove defined by the rotating shaft, which holds the front wheel within the circular mount and fixed relative to the rest of the collapsible wagon. The annular nature of the groove of the rotating shaft again dictates that the inner edge of the O-shaped portion remains within the groove regardless of the rotational position of the front wheel and the rotating shaft relative to the circular mount.

The tabs of the releasable front wheels also include an actuation portion located adjacent to the O-shaped portion. The actuation portion extends through a slot defined in a cover having an opening through which the rotating shaft extends. A distal end of the actuation portion of the tab extends out from the slot in the cover. The distal end is viewable and accessible by the user. When the user desires to disengage one of the front wheels from the collapsible wagon, the user presses the distal end of the actuation portion of the tab, translating the tab, which compresses the spring located between the O-shaped portion and the plate. Translating the tab also causes the inner edge of the O-shaped portion to momentarily come free from the annular groove of the rotating shaft, which allows the user to pull the front wheel and the rotating shaft from the circular mount (here downwardly) and the remainder of the collapsible wagon.

In an embodiment, the beveled ends of rotating shafts of the front wheels extend further from the annular grooves than the rotating shafts of the rear wheels. Nevertheless, the ends of the rotating shafts of the front wheels are again beveled to aid in the reinsertion of the front wheel and the rotating shaft into the circular mount. Upon reinsertion of the front wheel (or new front wheel) and associated rotating shaft, the angled surface of the beveled end contacts the inner edge of the O-shaped portion of the tab, pushing the O-shaped portion outwardly along the angled surface. Eventually, the O-shaped portion reaches the end of the angled surface and moves along the constant diameter of the rotating shaft until snap-fitting into the annular groove. At that point, the front wheel is again rotatably attached to the remainder of the collapsible wagon.

The collapsible wagon of the present disclosure may further include a parking brake assembly. The parking brake assembly in an embodiment incudes a brake foot pedal, which is hinged to a brake mount allowing the user to rotatably lower and lift the brake foot pedal with their foot relative to the mount to engage and disengage, respectively, the braking of the parking brake assembly. In an embodiment, the brake mount is formed with or is attached to the plate referenced above for engaging one end of the compression springs for the front releasable wheels. The brake foot pedal is located beneath the lever foot pedal in one embodiment. The brake mount may form a groove that sets the length and direction of the rotational travel of the brake foot pedal relative to the brake mount. Rotating the brake foot pedal moves a beveled head of the foot pedal within the groove of the brake mount. The beveled head is in one embodiment spring-loaded via a compression spring located within the brake foot pedal.

The time that the rear wheels are about to be engaged by the parking brake locking pins corresponds to the time at which the lower end of spring-loaded beveled head reaches a bottom of the groove in the brake mount. The user is then forced to increase downward foot pressure on the foot pedal (providing tactile locking feedback) so as to compress the spring to allow the beveled head to slide up over the bottom end of the groove, slide over a portion of an outer wall of the brake mount and into an opening formed in the brake mount beneath the groove, wherein the opening is sized to hold the beveled head releasably fixed. The foot pedal is now releasably locked in the parking brake engaged position, while the rear wheels have received the locking pins. The rear wheels remain locked until the user places their foot underneath the foot pedal and pushes up on the pedal. The user is required to supply enough force to the foot pedal (providing tactile unlocking feedback) so as to compress the spring to allow the beveled head to slide up over the top end of the opening, slide over the same portion of the outer wall of the brake mount and back into the groove via uncoiling pressure from the spring. The beveled head being located back in the groove corresponds to the parking break locking pins having been removed from the rear wheels. The user is now free to push or pull the collapsible wagon of the present disclosure.

The brake foot pedal is hingedly connected to the brake mount via a hinge, which is inserted through a pair of arms of the brake foot pedal that extend around the outside of a portion of the brake mount, through which the hinge also extends. The end of the brake foot pedal on the opposing side of the hinge from where the user actuates the foot pedal is connected to the ends of a pair of cables or wires. A cable or wire extends from the end of the brake foot pedal, through a protective tube, along the bottom of the collapsible wagon, e.g., generally following the base frame, to each of the rear wheels.

The cable or wire at each rear wheels is held fixed via an arm extending off of a rotatable collar. A compression spring is provided to maintain tension on the rotatable collar and to maintain the rotatable collar in a parking brake unlocked or disengaged position. The hinged connection of the brake foot pedal to the brake mount dictates that the user pressing down on the foot pedal causes the opposite end of the foot pedal, which is connected to the cables or wires, to rotate upwardly, which in turn pushes the cables or wires simultaneously within their guiding tubes, so that the arm and rotatable collar located at the respective rear wheel end of the cables or wires are rotated against the force of the spring and into a parking brake locked or engaged position.

The rotatable collar includes an inner cylindrical portion and an outer cammed surface portion, which is also cylindrical. The parking break locking pin is positioned adjacent to and generally in parallel with the rotatable collar. The parking break locking pin includes (e.g., is formed with or is inserted with) a cam follower pin, a portion of which is positioned so as to ride along the cammed surface portion of the rotatable collar. When the compression spring is maintaining tension on the cable or wire and the rotatable collar is rotated into in the parking brake unlocked or disengaged position, the cam follower pin is located along a section of the cammed surface that prevents the parking break locking pin from entering one of a plurality of parking break receiving holes. Additionally, a second compression spring biased to push the parking break locking pin into one of the plurality of parking break receiving holes is held in a compressed state.

When the user steps on the parking break foot pedal to cause the cable or wire to rotate the rotatable collar into in the parking brake locked or engaged position, the cam follower pin is in turn moved along the cammed surface to a section of the cammed surface that allows the parking break locking pin to enter one of the plurality of parking break receiving holes. Additionally, the second compression spring biased to push the parking break locking pin into one of the plurality of parking break receiving holes is now allowed to expand and move the parking break locking pin to releasably engage the parking brake of the collapsible wagon of the present disclosure. In an embodiment, the above-described locking or engaging procedure is performed on both rear wheels.

Again, to release the parking brake, the user pushes up on the bottom of the foot pedal and the above-described procedure operates in reverse. As soon as the spring-loaded beveled head reenters the groove in the brake mount, the spring biased to keep tension on the cable or wire is allowed to do so, rotating the rotatable collar into in the parking brake unlocked or disengaged position, wherein the cam follower pin is in turn rotated in the opposite direction along the cammed surface to the section that removes the parking break locking pin from the engaged one of the plurality of parking break receiving holes. Additionally, the spring biased to push the parking break locking pin into one of the holes is recompressed. In an embodiment, the above-described unlocking or disengaging procedure is performed on both rear wheels.

In light of the disclosure set forth herein, and without limiting the disclosure in any way, in a first aspect of the present disclosure, which may be combined with any other aspect, or portion thereof, a collapsible wagon includes a base frame; a lever hingedly connected to the base frame adjacent to a first end of the wagon; a holder frame hingedly connected to the lever adjacent to a second end of the wagon; and wherein the lever includes a lever foot pedal positioned and arranged to enable a user to step on the lever foot pedal to hingedly open the lever relative to the base frame.

In a second aspect of the present disclosure, which may be combined with any other aspect, or portion thereof, at least one of the base frame, the lever or the holder frame is tubular.

In a third aspect of the present disclosure, which may be combined with any other aspect, or portion thereof, the holder frame is configured to hold at least one curtain forming at least one collapsible wall of the wagon.

In a fourth aspect of the present disclosure, which may be combined with any other aspect, or portion thereof, the second end of the wagon includes a second end seat back and a second end seat bottom, and which is configured such that the user stepping on the lever foot pedal causes the second end seat back to rotate away from the second end seat bottom.

In a fifth aspect of the present disclosure, which may be combined with any other aspect, or portion thereof, the second end seat back is hingedly connected to the lever, such that hingedly opening the lever relative to the base frame additionally rotates the second end seat back away from the second end seat bottom.

In a sixth second aspect of the present disclosure, which may be combined with any other aspect, or portion thereof, the second end seat back is hingedly connected to the second end seat bottom.

In a seventh aspect of the present disclosure, which may be combined with any other aspect, or portion thereof, the collapsible wagon includes at least one hinge hingedly connecting the second end seat back to the lever, wherein the at least one hinge extends at least substantially horizontally when the second end seat back is rotated over the second end seat bottom, and wherein the at least one hinge extends at least substantially vertically when the second end seat back is rotated away from the second end seat bottom.

In an eighth aspect of the present disclosure, which may be combined with any other aspect, or portion thereof, the collapsible wagon includes at least one hinge hingedly connecting the second end seat back to the lever, wherein the at least one hinge extends at least substantially horizontally when the lever is in a collapsed positions, and wherein the at least one hinge extends at least substantially vertically when the lever is in an opened position.

In a ninth aspect of the present disclosure, which may be combined with any other aspect, or portion thereof, the collapsible wagon is configured such that the lever extends around an outside of the second end seat back when the lever is opened relative to the base frame.

In a tenth aspect of the present disclosure, which may be combined with any other aspect, or portion thereof, the first end of the wagon includes a first end seat back hingedly connected to a first end seat bottom.

In an eleventh aspect of the present disclosure, which may be combined with any other aspect, or portion thereof, the first end of the wagon includes a first end seat back and a first end seat bottom, and which is configured such that the user opening the first end seat back from the first end seat bottom causes the holder frame to hinge open from the lever.

In a twelfth aspect of the present disclosure, which may be combined with any other aspect, or portion thereof, the collapsible wagon is configured such that the holder frame hinging open from the lever causes at least a portion of a collapsible wall to open.

In a thirteenth aspect of the present disclosure, which may be combined with any other aspect, or portion thereof, the collapsible wagon includes at least one hinge hingedly connecting the first end seat back to the holder framer, wherein the at least one hinge extends at least substantially horizontally when the first end seat back is rotated over the first end seat bottom, and wherein the at least one hinge extends at least substantially vertically when the first end seat back is rotated away from the first end seat bottom.

In a fourteenth aspect of the present disclosure, which may be combined with any other aspect, or portion thereof, the collapsible wagon includes at least one hinge hingedly connecting the second end seat back to the lever, wherein the at least one hinge extends at least substantially horizontally when the lever is in a collapsed positions, and wherein the at least one hinge extends at least substantially vertically when the lever is in an opened position.

In a fifteenth aspect of the present disclosure, which may be combined with any other aspect, or portion thereof, the collapsible wagon is configured such that the holder frame extends around an outside of the first end seat back when the first end seat back is rotated away from the first end seat bottom.

In a sixteenth aspect of the present disclosure, which may be combined with any other aspect, or portion thereof, a collapsible wagon includes a base frame; a lever hingedly connected to the base frame adjacent to a first end of the wagon; and a seat back and a seat bottom located at an end of the wagon, and wherein the wagon is configured such that the user rotating the lever up from the base frame causes the seat back to rotate away from the seat bottom.

In a seventeenth aspect of the present disclosure, which may be combined with any other aspect, or portion thereof, the seat back is hingedly connected to the lever, such that rotating the lever up from the base frame additionally rotates the seat back away from the seat bottom.

In an eighteenth aspect of the present disclosure, which may be combined with any other aspect, or portion thereof, the seat back is hingedly connected to the seat bottom.

In a nineteenth aspect of the present disclosure, which may be combined with any other aspect, or portion thereof, a collapsible wagon includes a base frame; a lever hingedly connected to the base frame adjacent to a first end of the wagon; a holder frame hingedly connected to the lever adjacent to a second end of the wagon; a second end seat back and a second end seat bottom located at the second end of the wagon, and wherein the wagon is configured such that the user rotating the lever up from the base frame causes the second end seat back to rotate away from the second end seat bottom; and a first end seat back and a first end seat bottom located at the first end of the wagon, and wherein the wagon is configured such that the user opening the first end seat back from the first end seat bottom causes the holder frame to hinge open from the lever.

In a twentieth aspect of the present disclosure, which may be combined with any other aspect, or portion thereof, wherein the second end seat back is hingedly connected to the base frame, and wherein the first end seat back is hingedly connected to the holder frame.

In a twenty-first aspect of the present disclosure, which may be combined with any other aspect, or portion thereof, a collapsible wagon includes a base frame; a lever hingedly connected to the base frame; a seat back hingedly connected to the lever such that when the seat back is opened, the seat back and the lever rotate together into a locked relationship; and a release mechanism positioned and arranged to enable a user to release the seat back from the locked relationship with the lever.

In a twenty-second aspect of the present disclosure, which may be combined with any other aspect, or portion thereof, the lever is hingedly connected to the base frame at a first end of the wagon, and wherein the seat back is hingedly connected to the lever at a second end of the wagon.

In a twenty-third aspect of the present disclosure, which may be combined with any other aspect, or portion thereof, the collapsible wagon includes a seat bottom hingedly connected to the seat back.

In a twenty-fourth aspect of the present disclosure, which may be combined with any other aspect, or portion thereof, the seat bottom is supported by the base frame.

In a twenty-fifth aspect of the present disclosure, which may be combined with any other aspect, or portion thereof, the lever is configured to be actuated by a user, and wherein actuation of the lever causes the seat back and the lever to rotate together into the locked relationship.

In a twenty-sixth aspect of the present disclosure, which may be combined with any other aspect, or portion thereof, the release mechanism is carried by the seat back.

In a twenty-seventh aspect of the present disclosure, which may be combined with any other aspect, or portion thereof, the locked relationship includes a member of the release mechanism being inserted into a catch provided by the lever.

In a twenty-eighth aspect of the present disclosure, which may be combined with any other aspect, or portion thereof, the release mechanism includes a user-actuatable button and at least one cable interfacing with the member and the user-actuatable button, wherein actuation of the user-actuatable button causes the at least one cable to pull the member from the catch to release the seat back from the locked relationship with the lever.

In a twenty-ninth aspect of the present disclosure, which may be combined with any other aspect, or portion thereof, the user-actuatable button is configured to slide along a portion of the seat back.

In a thirtieth aspect of the present disclosure, which may be combined with any other aspect, or portion thereof, the collapsible wagon includes at least one spring positioned and arranged to maintain the slidable button in a centered position such that the button may be actuated in two directions.

In a thirty-first aspect of the present disclosure, which may be combined with any other aspect, or portion thereof, an inserted end of the member is beveled, and wherein the seat back and the lever are configured such that the catch engages the beveled end and pushes the member over the catch so as to become inserted into the catch when the seat back and the lever are rotated together into the locked relationship.

In a thirty-second aspect of the present disclosure, which may be combined with any other aspect, or portion thereof, the slidable button includes a downwardly extending tab that becomes aligned with an upwardly extending tab of the member when the beveled end of the member is inserted into the catch, the aligned tabs locking the beveled end of the member in the catch until the slidable button is translated so that the downwardly extending tab of the slidable button is no longer aligned with the upwardly extending tab of the member.

In a thirty-third aspect of the present disclosure, which may be combined with any other aspect, or portion thereof, the seat back provides an opening to allow a handle formed with or connected to the member to be accessed by the user when the user translates the slidable button, the handle enabling the user to lift the beveled end of the member from the catch to rotate the seat back.

In a thirty-fourth aspect of the present disclosure, which may be combined with any other aspect, or portion thereof, the collapsible wagon includes at least one hinge hingedly connecting the seat back to the lever, the at least one hinge extending at least substantially horizontally when the seat back is collapsed, the at least one hinge extending at least substantially vertically when the seat back is opened.

In a thirty-fifth aspect of the present disclosure, which may be combined with any other aspect, or portion thereof, the collapsible wagon includes a holder frame hingedly connected to the lever, wherein the seat back is a first seat back and the release mechanism is a first release mechanism, and which includes a second seat back, wherein the second seat back is hingedly connected to the holder frame such that when the second seat back is opened, the second seat back and the holder frame rotate together into a locked relationship.

In a thirty-sixth aspect of the present disclosure, which may be combined with any other aspect, or portion thereof, the release mechanism is a first release mechanism, and which includes a second release mechanism positioned and arranged to enable the user to release the second seat back from the locked relationship with the holder frame.

In a thirty-seventh aspect of the present disclosure, which may be combined with any other aspect, or portion thereof, the collapsible wagon includes a canopy holder (i) connected to and rotatable with the seat back or (ii) hingedly connected to the collapsible wagon such that the canopy holder is rotated opened or closed in a designated sequence with the seat back.

In a thirty-eighth aspect of the present disclosure, which may be combined with any other aspect, or portion thereof, a collapsible wagon includes a base frame; a seat bottom supported by the base frame; a seat back hingedly connected to the seat bottom such that when the seat back is opened, a translatable member of the back becomes locked within a catch; and a release mechanism comprising a slidable button that includes a downwardly extending tab that becomes aligned with an upwardly extending tab of the member when the member becomes locked within the catch, the aligned tabs locking the member in the catch until the slidable button is translated so that the downwardly extending tab of the slidable button is no longer aligned with the upwardly extending tab of the member.

In a thirty-ninth aspect of the present disclosure, which may be combined with any other aspect, or portion thereof, the seat back provides an opening to allow a handle formed with or connected to the member to be accessed by the user when the user translates the slidable button so that the downwardly extending tab of the slidable button is no longer aligned with the upwardly extending tab of the member, the handle enabling the user to lift the member from the catch to unlock the seat back.

In a fortieth aspect of the present disclosure, which may be combined with any other aspect, or portion thereof, the catch is provided by a portion of a frame, optionally the base frame, of the collapsible wagon.

In a forty-first aspect of the present disclosure, which may be combined with any other aspect, or portion thereof, a collapsible wagon includes a base frame; a lever hingedly connected to the base frame; a holder frame hingedly connected to the lever; a first seat back hingedly connected to the lever such that when the first seat back is opened, the first seat back and the lever rotate together into a first locked relationship; and a second seat back hingedly connected to the holder frame such that when the second seat back is opened, the second seat back and the holder frame rotate together into a second locked relationship.

In a forty-second aspect of the present disclosure, which may be combined with any other aspect, or portion thereof, the collapsible wagon is configured such that the first and second seat backs (i) are non-overlapping and collapsible in either order or (ii) are overlapping and collapsible in a designated order.

In a forty-third aspect of the present disclosure, which may be combined with any other aspect, or portion thereof, the collapsible wagon includes a rotatable handle, and which is configured such that the rotatable handle is collapsed after the first and second seat backs are collapsed.

In a forty-fourth aspect of the present disclosure, which may be combined with any other aspect, or portion thereof, the collapsible wagon is configured such that the rotatable handle is rotated open prior to rotating open the first and second seat backs.

In a forty-fifth aspect of the present disclosure, which may be combined with any other aspect, or portion thereof, a collapsible wagon includes a base frame; and a handle supported by the base frame, the handle including a handle shaft, a handle grip located at a first end of the handle shaft, a handle pivot located at a second end of the handle shaft, the handle pivot including a rotatable and translatable locking member and at least one non-rotatable wall defining a plurality of position setting notches for accepting the locking member to set the handle shaft at a desired position, and an actuator configured to enable a user to release the locking member from one of the notches to change the handle shaft to a different desired position.

In a forty-sixth aspect of the present disclosure, which may be combined with any other aspect, or portion thereof, the actuator and the rotatable and translatable locking member are part of a release mechanism that extends from the actuator to the handle pivot.

In a forty-seventh aspect of the present disclosure, which may be combined with any other aspect, or portion thereof, the release mechanism further includes at least one cable extending from the actuator to the rotatable and translatable locking member, the at least one cable configured to pull the rotatable and translatable locking member to release the locking member from one of the notches.

In a forty-eighth aspect of the present disclosure, which may be combined with any other aspect, or portion thereof, the at least one non-rotatable wall includes an upper circular portion, and wherein the plurality of position setting notches are defined along the upper circular portion.

In a forty-ninth aspect of the present disclosure, which may be combined with any other aspect, or portion thereof, the at least one non-rotatable wall includes a plurality of non-rotatable walls extending from a bottom wall, each of the non-rotatable walls defining plural position setting notches aligned so as to accept plural portions of the rotatable and translatable locking member.

In a fiftieth aspect of the present disclosure, which may be combined with any other aspect, or portion thereof, the rotatable and translatable locking member includes a bar that extends through or from a cylindrical portion of the rotatable and translatable locking member, the bar providing the plural portions of the rotatable and translatable locking member accepted by the aligned notches.

In a fifty-first aspect of the present disclosure, which may be combined with any other aspect, or portion thereof, a cross-sectional shape of the bar matches the shape of the notches of at least one set of aligned notches.

In a fifty-second aspect of the present disclosure, which may be combined with any other aspect, or portion thereof, the collapsible wagon includes a pivot shaft extending between the plurality of non-rotatable walls, the pivot shaft further extending through a slot defined by the cylindrical portion and allowing the rotatable and translatable locking member to rotate and translate relative to the pivot shaft.

In a fifty-third aspect of the present disclosure, which may be combined with any other aspect, or portion thereof, the bottom wall defines an aperture for accepting an end of the cylindrical portion of the rotatable and translatable locking member when translated towards the bottom wall.

In a fifty-fourth aspect of the present disclosure, which may be combined with any other aspect, or portion thereof, the shape of at least one of the notches is configured to prevent movement of the accepted locking member in either rotational direction.

In a fifty-fifth aspect of the present disclosure, which may be combined with any other aspect, or portion thereof, the shape of at least one of the notches is configured to prevent movement of the accepted locking member in a first rotational direction and to allow movement of the accepted locking member in a second rotational direction.

In a fifty-sixth aspect of the present disclosure, which may be combined with any other aspect, or portion thereof, the actuator includes a pivoting latch provided at the handle grip.

In a fifty-seventh aspect of the present disclosure, which may be combined with any other aspect, or portion thereof, the pivoting latch is spring-biased closed against the handle grip.

In a fifty-eighth aspect of the present disclosure, which may be combined with any other aspect, or portion thereof, the handle further includes a handle extension extending from the base frame, the handle extension offsetting the handle pivot so that the handle pivot and the handle grip when rotated to a stowed position extend over at least one stowed seat back of the collapsible wagon.

In a fifty-ninth aspect of the present disclosure, which may be combined with any other aspect, or portion thereof, the plurality of position setting notches for accepting the locking member include a stowed position notch, an upright position notch and an end of travel position notch.

In a sixtieth aspect of the present disclosure, which may be combined with any other aspect, or portion thereof, the collapsible wagon is configured such that at least one seat back of the collapsible wagon needs to be rotated to a stowed position before the locking member can be rotated to the stowed position notch.

In a sixty-first aspect of the present disclosure, which may be combined with any other aspect, or portion thereof, a handle for a collapsible wagon includes a handle shaft; a handle grip located at a first end of the handle shaft; a handle pivot located at a second end of the handle shaft, the handle pivot including a rotatable and translatable locking member and a plurality of non-rotatable walls each defining a plurality of aligned position setting notches for accepting the locking member to set the handle shaft and the handle pivot at a desired position; and an actuator configured to enable a user to release the locking member from one set of aligned positon setting notches to change the handle shaft and the handle pivot to a different desired position.

In a sixty-second aspect of the present disclosure, which may be combined with any other aspect, or portion thereof, the plurality of position setting notches for accepting the locking member include a stowed position notch, an upright position notch and an end of travel position notch, and wherein the end of travel position notch is configured to enable the user during operation to rotate the handle shaft anywhere between an edge of the end of travel position notch and the upright position notch.

In a sixty-third aspect of the present disclosure, which may be combined with any other aspect, or portion thereof, the handle includes a spring biased to maintain the locking member in one of the sets of aligned position setting notches.

In a sixty-fourth aspect of the present disclosure, which may be combined with any other aspect, or portion thereof, a children's wagon includes at least one wheel; at least one rotating shaft extending from the at least one wheel, the at least one rotating shaft defining an annular groove; at least one tab including an actuation portion and an engagement portion configured to extend into the annular groove of the at least one rotating shaft; and at least one spring positioned and arranged to bias the at least one tab such that the engagement portion extends into the annular groove of the at least one rotating shaft, and wherein the at least one actuation portion of the at least one tab is accessible to a user to press, causing the at least one spring to compress and the at least one engagement portion to come free from the at least one annular groove, allowing the at least one wheel to be removed from the at least one rotating shaft.

In a sixty-fifth aspect of the present disclosure, which may be combined with any other aspect, or portion thereof, the children's wagon includes a base frame, and wherein the at least one wheel is held fixed to the base frame.

In a sixty-sixth aspect of the present disclosure, which may be combined with any other aspect, or portion thereof, at least one of the at least one wheel is held fixed to the base frame via at least one leg extending from the base frame.

In a sixty-seventh aspect of the present disclosure, which may be combined with any other aspect, or portion thereof, the children's wagon includes a seat bottom attached to the base frame, and wherein at least one of the at least one wheel is held fixed to the seat bottom.

In a sixty-eighth aspect of the present disclosure, which may be combined with any other aspect, or portion thereof, at least one of the at least one rotating shaft includes a beveled end positioned and arranged to contact the engagement portion of the corresponding tab to move the tab outwardly, compressing the corresponding spring, enabling the engagement portion to extend into the annular groove of the rotating shaft for wheel attachment to the wagon.

In a sixty-ninth aspect of the present disclosure, which may be combined with any other aspect, or portion thereof, at least one of the at least one wheel includes a cover extending over the corresponding tab, the cover defining a slot through which the actuation portion extends so as to be accessible to the user.

In a seventieth aspect of the present disclosure, which may be combined with any other aspect, or portion thereof, the at least one rotating shaft extends horizontally when the wagon is in operation, and wherein the at least one wheel is removed horizontally from the at least one rotating shaft.

In a seventy-first aspect of the present disclosure, which may be combined with any other aspect, or portion thereof, the children's wagon includes at least one non-rotating tube extending over the at least one rotating shaft, the non-rotating tube defining a slot through which the engagement portion passes to extend into the annular groove of the at least one rotating shaft.

In a seventy-second aspect of the present disclosure, which may be combined with any other aspect, or portion thereof, the at least one tab includes an O-shaped portion providing the engagement portion for extending through the slot of the non-rotating tube, the O-shaped portion extending around the non-rotating tube.

In a seventy-third aspect of the present disclosure, which may be combined with any other aspect, or portion thereof, at least one of the at least one spring is positioned between the corresponding non-rotating tube and an inner edge of the O-shaped portion of the corresponding tab.

In a seventy-fourth aspect of the present disclosure, which may be combined with any other aspect, or portion thereof, the non-rotating tube extends to a pair of rear wheels of the children's wagon.

In a seventy-fifth aspect of the present disclosure, which may be combined with any other aspect, or portion thereof, the at least one rotating shaft is a swivel shaft for steering the wagon, and wherein the at least one wheel is removed substantially vertically from the at least one rotating shaft.

In a seventy-sixth aspect of the present disclosure, which may be combined with any other aspect, or portion thereof, the at least one tab includes an O-shaped portion providing the engagement portion for extending through the slot of the non-rotating tube, and wherein at least one of the at least one spring is positioned between the O-shaped portion of the corresponding tab and a fixture of the children's wagon.

In a seventy-seventh aspect of the present disclosure, which may be combined with any other aspect, or portion thereof, a children's wagon includes a wheel for operating the wagon; a rotating shaft extending from the wheel, the rotating shaft defining an annular groove; a tab including an actuation portion and an engagement portion configured to extend into the annular groove of the rotating shaft; and a spring positioned and arranged to bias the tab such that the engagement portion extends into the annular groove of the rotating shaft, and wherein the actuation portion of the tab is accessible to a user to press, causing the spring to compress and the engagement portion to come free from the annular groove, allowing the wheel to be removed from the rotating shaft.

In a seventy-eighth aspect of the present disclosure, which may be combined with any other aspect, or portion thereof, a children's wagon includes a wheel for operating the wagon, the wheel including a plurality of locking pin receiving holes; a brake mount; a foot pedal hingedly connected to the brake mount; a cable extending from the foot pedal to a rotatable collar located adjacent to the wheel; a spring biasing the rotatable collar into an unlocked position; and a locking pin mechanically linked to the rotatable collar, wherein actuation of the foot pedal causes the cable to rotate the rotatable collar against the spring and into a locked position in which the locking pin is urged into one of the plurality of locking pin receiving holes.

In a seventy-ninth aspect of the present disclosure, which may be combined with any other aspect, or portion thereof, the spring is biased to place tension on the cable, and wherein actuation of the foot pedal pushes the cable against the spring to rotate the rotatable collar into the locked position.

In an eightieth aspect of the present disclosure, which may be combined with any other aspect, or portion thereof, the rotatable collar includes a cammed surface portion, wherein the locking pin includes a cam follower pin positioned and arranged to engage the cammed surface portion, and wherein rotating the rotatable collar into the locked position causes the cam follower pin to move to a location along the cammed surface portion that allows the locking pin to be urged into one of the plurality of locking pin receiving holes.

In an eighty-first aspect of the present disclosure, which may be combined with any other aspect, or portion thereof, the spring is a first spring and which includes a second spring biased to urge the locking pin into one of the plurality of locking pin receiving holes when the cam follower pin is moved to the location along the cammed surface portion.

In an eighty-second aspect of the present disclosure, which may be combined with any other aspect, or portion thereof, the location is a first location and wherein the cam follower pin is located at a second location along the cammed surface portion when the rotatable collar is rotated to the unlocked position, the second location preventing the locking pin from being urged into one of the plurality of locking pin receiving holes.

In an eighty-third aspect of the present disclosure, which may be combined with any other aspect, or portion thereof, the spring is a first spring and which includes a second spring biased to urge the locking pin into one of the plurality of locking pin receiving holes, and wherein the second spring is held in a compressed state when the cam follower pin is located at the second location along the cammed surface portion.

In an eighty-fourth aspect of the present disclosure, which may be combined with any other aspect, or portion thereof, the brake mount includes a groove and the foot pedal includes a spring-loaded head that rides within the groove when the user actuates the foot pedal.

In an eighty-fifth aspect of the present disclosure, which may be combined with any other aspect, or portion thereof, the children's wagon includes an opening located adjacent to the groove, wherein the brake mount is configured such that the user is required to compress the spring-loaded head such that the spring-loaded head can exit the groove and enter the opening when the rotatable collar is rotated into the locked position in which the locking pin is urged into one of the plurality of locking pin receiving holes.

In an eighty-sixth aspect of the present disclosure, which may be combined with any other aspect, or portion thereof, the head of the spring-loaded head is a beveled head.

In an eighty-seventh aspect of the present disclosure, which may be combined with any other aspect, or portion thereof, the brake mount and the rotatable collar are configured such that the rotatable collar is rotated against the spring towards the locked position as the spring-loaded head is moved within the groove.

In an eighty-eighth aspect of the present disclosure, which may be combined with any other aspect, or portion thereof, the wheel is a first wheel, the cable is a first cable, the spring is a first spring, the rotatable collar is a first rotatable collar, and the locking pin is a first locking pin, and which includes a second wheel for operating the wagon, the second wheel including a plurality of second locking pin receiving holes; a second cable extending from the foot pedal to a second rotatable collar located adjacent to the second wheel; a second spring biasing the second rotatable collar into an unlocked position; and a second locking pin mechanically linked to the second rotatable collar, wherein actuation of the foot pedal causes the cable to rotate the second rotatable collar against the second spring and into a locked position in which the second locking pin is urged into one of the plurality of locking pin receiving holes of the second wheel.

In an eighty-ninth aspect of the present disclosure, which may be combined with any other aspect, or portion thereof, a children's wagon includes at least one collapsible fabric curtain or wall attached around a U-shaped curtain holder frame providing collapsible side walls.

In a ninetieth aspect of the present disclosure, which may be combined with any other aspect, or portion thereof, the at least one collapsible fabric curtain or wall includes at least one inner storage pocket.

In a ninety-first aspect of the present disclosure, which may be combined with any other aspect, or portion thereof, a collapsible wagon includes a base frame; a pair of front wheels coupled to the base frame; and a pair of rear wheels coupled to the base frame via a suspension system.

In a ninety-second aspect of the present disclosure, which may be combined with any other aspect, or portion thereof, the pair of rear wheels are removably coupled to the base frame.

In a ninety-third aspect of the present disclosure, which may be combined with any other aspect, or portion thereof, the suspension system remains coupled to the base frame when the pair of rear wheels are removed from the collapsible wagon.

In a ninety-fourth aspect of the present disclosure, which may be combined with any other aspect, or portion thereof, the suspension system remains coupled to the pair of rear wheels when the pair of rear wheels are removed from the collapsible wagon.

In a ninety-fifth aspect of the present disclosure, which may be combined with any other aspect, or portion thereof, any of the features, functionality and alternatives described in connection with any one or more of FIGS. 1 to 26 may be combined with any of the features, functionality and alternatives described in connection with any other of FIGS. 1 to 26.

In light of the above aspects and the disclosure set forth herein, it is accordingly an advantage of the present disclosure to provide a children's wagon that is collapsible.

It is another advantage of the present disclosure to provide a children's wagon that is sturdy yet relatively light weight.

It is a further advantage of the present disclosure to provide a children's wagon that is functionally easy to collapse.

It is yet another advantage of the present disclosure to provide a children's wagon that is functionally easy to open into an operable position.

It is yet a further advantage of the present disclosure to provide a children's wagon having front and rear seats that readily open and collapse.

It is still another advantage of the present disclosure to provide a children's wagon having front and rear seats that releasably lock in place when opened for use.

It is still a further advantage of the present disclosure to provide a children's wagon having a handle shaft that releasably locks in place when in upright and stowed positions.

Moreover, it is an advantage of the present disclosure to provide a children's wagon having releasable front and rear wheels for repair or replacement.

Further still, it is an advantage of the present disclosure to provide a children's wagon having an easy to use and effective parking brake.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a perspective view illustrating one embodiment of a collapsible wagon system of the present disclosure.

FIG. 2A is a different perspective view illustrating one embodiment of a collapsible wagon system of the present disclosure.

FIG. 2B is a perspective view of a portion of one embodiment of a collapsible wagon of the present disclosure having a rear seat back so as to show its slot mechanism for inserting safety straps.

FIG. 3 is a perspective view of a portion of one embodiment of a collapsible wagon of the present disclosure having a rear seat back hidden so as to show its seat release mechanism and associated hinges.

FIG. 4 is a perspective view of a portion of one embodiment of a collapsible wagon of the present disclosure having a front seat back hidden so as to show its seat release mechanism and associated hinges.

FIG. 5 is a perspective view of a portion of one embodiment of a collapsible wagon of the present disclosure having a front seat back hidden so as to show its seat release mechanism, associated catch and associated hinges.

FIG. 6 is a perspective view of one embodiment for the front seat back release mechanism of the present disclosure having a beveled end for being inserted into an associated catch upon opening of the front seat back.

FIG. 7 is a perspective view of a portion of one embodiment of a collapsible wagon of the present disclosure having a rear seat back hidden so as to show its seat release mechanism, associated catch and associated hinges.

FIG. 8 is a perspective view of one embodiment for the rear seat back release mechanism of the present disclosure having a beveled end for being inserted into an associated catch upon opening of the rear seat back.

FIG. 9 is a perspective view of a portion of one embodiment of a collapsible wagon of the present disclosure having a pivoting handle.

FIG. 10 is an enlarged perspective view of a handle grip of the present disclosure showing a portion of an associated handle release mechanism.

FIG. 11A is a perspective view showing a hinge portion of a handle release mechanism of the present disclosure.

FIG. 11B is a different perspective view showing a hinge portion of a handle release mechanism of the present disclosure.

FIG. 12 is a cutaway perspective view illustrating one embodiment of releasable rear wheel of the collapsible wagon of the present disclosure.

FIGS. 13 and 14 are sectioned perspective views illustrating one embodiment of a mechanism that allows the rear wheels to be removed in a sideways direction from the collapsible wagon of the present disclosure.

FIG. 15 is a cutaway perspective view illustrating a tube within which a rotating wheel shaft is located, the tube providing a slot for receiving a locking projection of a user actuatable tab.

FIG. 16 is a cutaway perspective view illustrating one embodiment of releasable front wheel of the collapsible wagon of the present disclosure.

FIGS. 17 and 18 are sectioned perspective views illustrating one embodiment of a mechanism that allows the front wheels to be removed in a downward direction from the collapsible wagon of the present disclosure.

FIG. 19 is a sectioned perspective view illustrating one embodiment of a rotating shaft of the releasable front wheels of the present disclosure.

FIG. 20 is a cutaway perspective view of one embodiment of a parking brake assembly of the collapsible wagon of the present disclosure.

FIG. 21 is a cutaway perspective view illustrating one embodiment for a brake mount/brake foot pedal interaction of the parking brake assembly of the present disclosure.

FIG. 22 is another cutaway perspective view illustrating one embodiment for a brake mount/brake foot pedal interaction of the parking brake assembly of the present disclosure.

FIG. 23 is a cutaway perspective view illustrating one embodiment for a cable, rotating collar and locking pin interaction of the parking brake assembly of the present disclosure.

FIG. 24 is another cutaway perspective view illustrating one embodiment for a cable, rotating collar and locking pin interaction of the parking brake assembly of the present disclosure.

FIG. 25A is a perspective view illustrating one embodiment of a collapsible wagon system having a canopy and collapsible fabric curtains or walls.

FIG. 25B is a perspective view of a portion of one embodiment of a collapsible wagon of the present disclosure having collapsible fabric curtains or walls so as to show its inner storage pockets.

FIGS. 26A-E are conceptual illustrations of a rear wheel suspension system in accordance with a variety of embodiments of the present disclosure.

### DETAILED DESCRIPTION

### System Overview

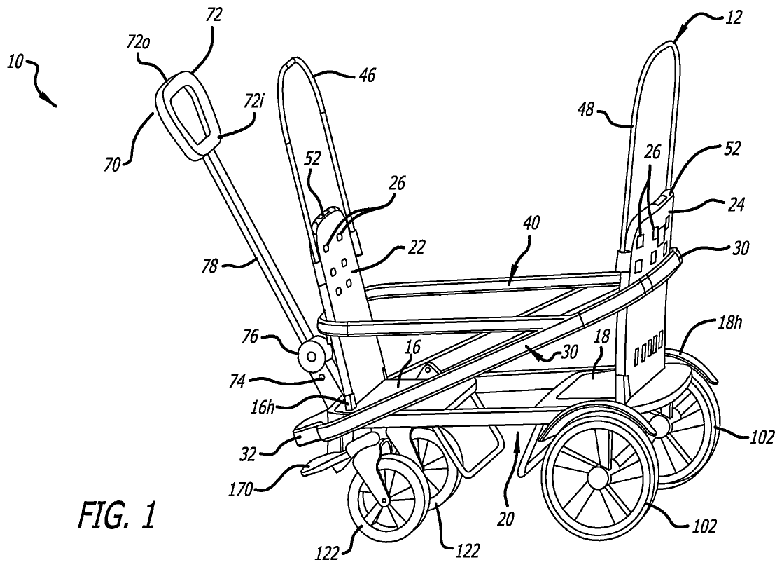

Referring now to the drawings and in particular to FIGS. 1,2A, 2B, 25A, 25B, and 26A-E, an embodiment of a collapsible wagon system of the present disclosure is illustrated by system 10. System 10 includes a collapsible wagon 12 along with optional accessories discussed herein. Any rigid part and flexible tubing of collapsible wagon 12 may be made (e.g., molded) of any one or more plastic, e.g., polyvinylchloride (“PVC”), polyethylene (“PE”), polyurethane (“PU”), polycarbonate (“PC”), polypropylene (“PP”), and/or polyetheretherketone (“PEEK”). Any rigid part of collapsible wagon 12 may be made (e.g., machined, formed or cast) alternatively or additionally of any one or more metal, e.g., stainless steel, steel and/or aluminum.

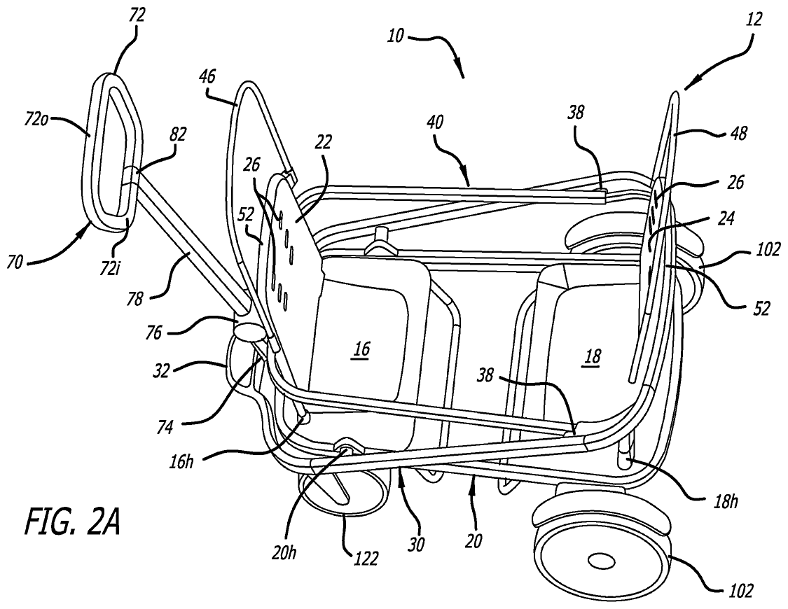

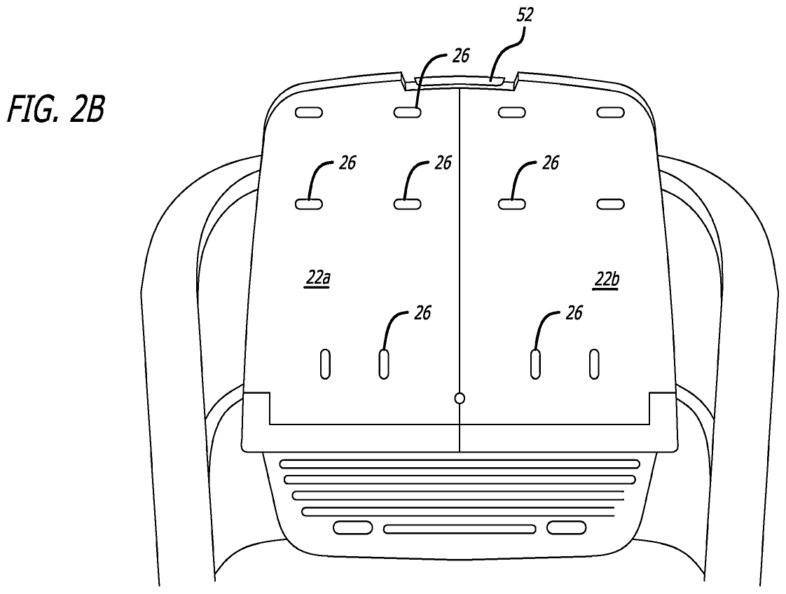

Collapsible wagon 12 in one embodiment includes a base frame 20, which may include a circumferential tube, e.g., rectangular tube, which essentially defines the footprint of the collapsible wagon. Base frame 20 directly or indirectly supports a front seat bottom 16 and a rear seat bottom 18. Seat bottoms 16, 18 in one embodiment include hinges 16h, 18h that extend upwardly from the seat bottoms and allow front and rear seat backs 22, 24 to connect rotatably to the front and rear seat bottoms 16, 18, respectively. Seat bottoms 16, 18 and seat backs 22, 24 may be provided with slots 26 that allow safety straps to be fitted though the slots to hold children comfortably in place within wagon 12. As shown in FIGS. 1, 2A, and 2B, seat bottoms 16, 18 and seat backs 22, 24 may be provided with slots 26 that allow safety straps (and/or any type of harness or seat belt) to be fitted though the slots to hold children comfortably in place within wagon 12. The front seat and/or rear seat can be formed out of any material or combination of materials, including plastics and metals as described herein, fabrics (including natural and/or synthetic fabrics), padded materials, and meshes as appropriate to the requirements of specific applications of the disclosure. In a variety of aspects, the front seat and/or rear seat can have an inner frame formed from a rigid material covered in a softer fabric and/or padded element. Each of the seat bottoms 16, 18 and/or seat backs 22, 24 can be dimensioned to hold one or more children within the width collapsible wagon 12. For example, the front seat can be dimensioned to hold a single child while the rear seat is dimensioned to hold two children sitting side by side. Accordingly, as shown in FIG. 2B, the rear seat 22 sized for two occupants can have safety straps arranged for side-by-side seating (22a, 22b) for both occupants to be individually restrained. In some embodiments, the same side-by-side seat 22a, 22b can be configured to route safety straps for a single middle occupant by rerouting straps through existing shared slots 26 to keep the single occupant centered in the wagon while sitting on a dual-occupant seat. In a variety of embodiments, rather than rerouting any safety straps, a single center occupant can use one strap from the left side safety strap system with a cooperating second strap from the right side safety strap system. In this way, the collapsible wagon 12 can support a variety of seating configurations and restraints.

FIG. 2A illustrates that base frame 20 includes or is fitted with lever hinges 20h, which hingedly connect to two sides of a tubular lever 30. Tubular lever 30 in the illustrated embodiment is also circumferential and extends around the entire, or almost the entire, collapsible wagon 12. Tubular lever 30 in the illustrated embodiment is hinged on the front seat side of base frame 20 and extends around the outside of rear seat back 24, so as to be able to rotate towards and away from the rear seat side of the base frame.

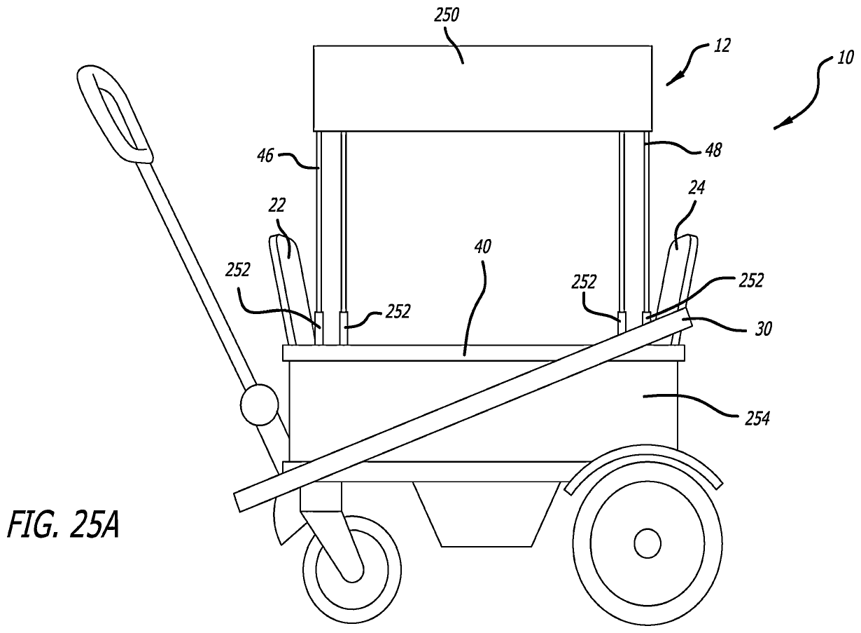

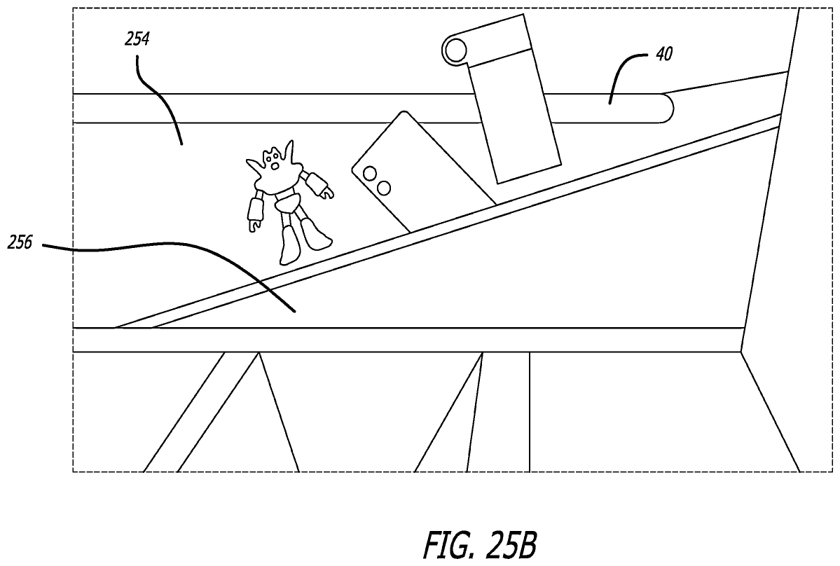

A curtain holder frame 40 is hingedly connected via hinges 38 (FIG. 2A) at two places to the rear seat side of tubular lever 30. Curtain holder frame 40 may be tubular and generally U-shaped so as to extend around the outside of front seat back 22, and so as to be able to rotate towards and away from the front seat side of tubular lever 30. FIG. 25A illustrates that a collapsible fabric curtain) or wall 254 is attached in one embodiment around the U-shaped curtain holder frame 40 so as to provide collapsible front and side walls. The same collapsible curtain or wall 254 or a separate collapsible fabric curtain or wall may be attached to the rear seat end of tubular lever 30 to provide a collapsible rear wall of wagon 12. FIG. 25B illustrates that the same collapsible fabric curtain or wall 254 may contain an inner storage pocket 256.

### Stowed and Operable Position Transition

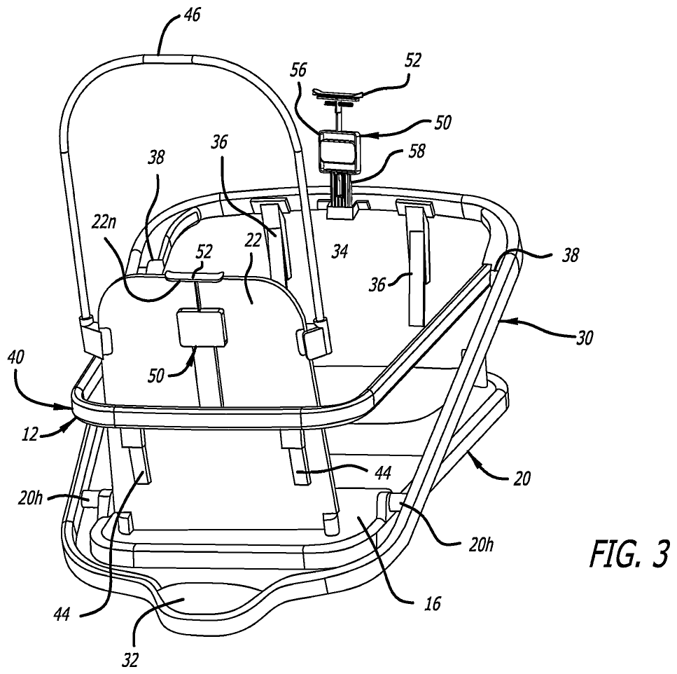

FIGS. 3 to 8 illustrate that base frame 20, tubular lever 30 and curtain holder frame 40 are hingedly attached so as to provide an accordion type structure that can be expanded to open wagon 12 to an open position and to collapse the wagon to a collapsed position. FIG. 3 illustrates that curtain holder frame 40 is hinged to tubular lever 30 via hinges 38. In an embodiment, front seat back 22 is hingedly connected via hinges 44 to the front seat side of curtain holder frame 40, while rear seat back 24 is hingedly connected via hinges 36 to the rear seat side of tubular lever 30. Movement of curtain holder frame 40 and tubular lever 30 is accordingly mechanically linked to the movement of front and rear seat backs 22, 24 in the illustrated embodiment.

FIGS. 3 to 8 further illustrate that front and rear seat backs 22, 24 are each provided in one embodiment with release mechanisms 50, which may be sliding release mechanisms, which the user actuates or slides to enable front and rear seat backs 22, 24 to be folded down onto respective front and rear seat bottoms 16, 18. In an embodiment, collapsible wagon 12 is configured such that the user does not have to actuate the front and rear seat release mechanisms to rotate front and rear seat backs 22, 24 up from front and rear seat bottoms 16, 18, respectively, but when rotated fully upward, front and rear seat backs 22, 24 become locked in place and cannot be rotated back down onto the front and rear seat bottoms 16, 18 without actuation of release mechanism 50.

Front and rear seat release mechanisms 50 are configured and operate in the same manner for front and rear seat backs 22, 24 in one embodiment, the consistency of which is advantageous to the user. Front and rear seat release mechanisms 50 in one embodiment each include a slidable button 52 that slides or translates within an elongated notch 22n, 24n located at the top of the front and rear seat backs 22, 24. A tab 52t extends down from slidable button 52 in one implementation (tab 52t being formed with or attached to button 52), wherein one or more spring 54 is provided to push against tab 52t and bias slidable button 52 towards a center of notch 22n, 24n located at the top of the front and rear seat backs 22, 24. In the illustrated embodiment tab 52t and multiple springs 54 allow the user to slide button 52 in either direction to actuate front and rear seat release mechanisms 50, releasing the front and rear seat backs to be rotated to a collapsed or stowed position. As described below, when slidable button 52 is not actuated and is centered by one or more spring 54, tab 52t blocks the user from moving a handle 56 to release the front and rear seat backs 22, 24 for collapsing same onto their respective seat bottoms 16, 18.

In the illustrated embodiment for each seat back 22, 24, tab 52t of slidable button 52 is aligned with and may abut a like tab 56t extending up from a handle 56 of front and rear seat release mechanisms 50. One or more spring 54 of front and rear seat release mechanisms 50 is/are biased so as to maintain the front and rear seat back members 22, 24 in their locked positions. When the user slides or translates one of slidable buttons 52 in either direction, the button slides its associated tab 52t so that it is no longer in registry with, and no longer blocks, tab 56t extending up from a handle 56 of front or rear seat release mechanism 22, 24. The user is then able (with the slidable button still actuated) to grasp and lift up the handle 56, which may be accessed through an opening located on the backside of front or rear seat back 22, 24, which in turn pulls a member 58 out from its associated catch 34, 42. Member 58 may be formed with or attached to handle 56. When member 58 is pulled from catch 34, 42, the hinges 44, 36 connecting seat back 22, 24 to the curtain holder frame 40 or tubular lever 30 become unlocked, allowing the user to rotate and collapse seat back 22, 24 onto its respective seat bottom 16, 18.

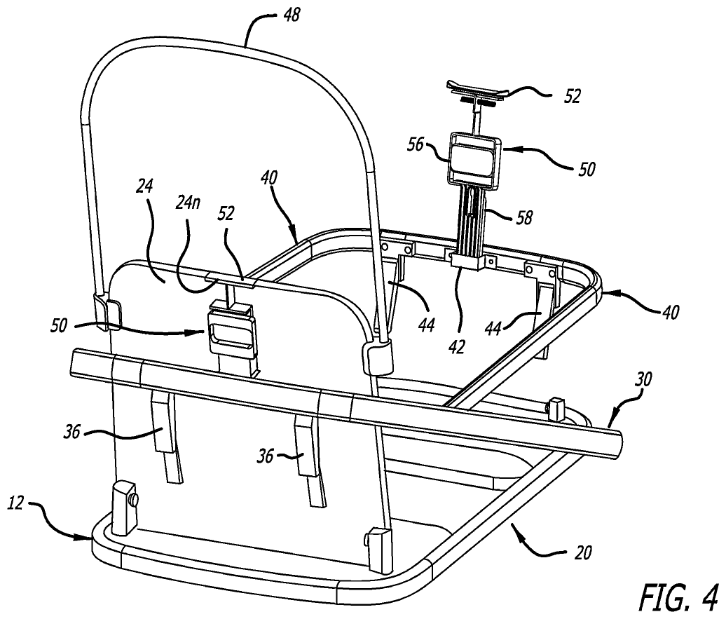

FIG. 4 (front seat back 22 removed for clarity) illustrates that catch 42 for securing front seat back member 58 is provided by curtain holder frame 40 in the illustrated embodiment, so that when front seat back member 58 is located within catch 42 of curtain holder frame 40, hinges 44 connecting front seat back 22 (removed for clarity) to the curtain holder frame are locked and neither front seat back 22 or curtain holder frame 40 can be rotated or collapsed.

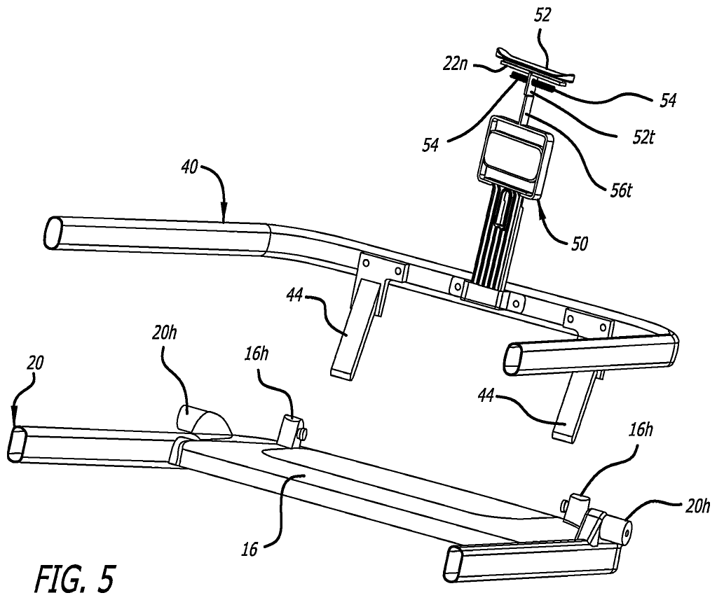

FIG. 5 illustrates that front seat bottom 16 is in one embodiment attached to or otherwise supported by base frame 20. FIG. 5 also clearly shows lever hinges 20h fitted to or formed with base frame 20. In several embodiments, lever hinges 20h hingedly attach to tubular lever 30 (not shown). FIG. 5 further clearly shows hinges 16h that extend upwardly from front seat bottom 16 and allow front seat back 22 (removed for clarity) to connect rotatably to front seat bottom 16.

As shown in FIGS. 4-8, Release mechanism 50, including slidable button 52, one or more spring 54, handle 56 and member 58, are provided within and thus rotate with front seat back 22 (removed for clarity). The user does not have to actuate slidable button 52 to rotate front seat back 22 up from front seat bottom 16. But when front seat back 22 is rotated fully up from front seat bottom 16, member 58 slides downwardly into catch 42 of curtain holder frame 40, locking front seat back 22 and curtain holder frame 40 releasably in place. Viewing FIG. 5, when front seat back 22 is in its collapsed position lying on top of front seat bottom 16, curtain holder frame 40 is rotated down essentially onto base frame 20, and hinges 44 are rotated forward to essentially horizontal positions, allowing the front end of curtain holder frame 40 to be spaced away from front seat back 22. As front seat back 22 is rotated up from front seat bottom 16, hinges 44 rotate into increasingly more vertical positions as shown in FIG. 5, allowing the front end of curtain holder frame 40 (having catch 42) to come increasingly closer to front seat back 22.

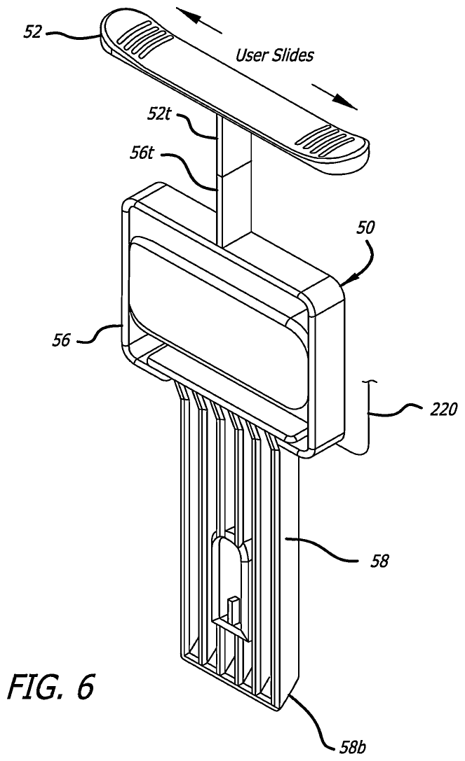

FIG. 6 illustrates that member 58 of release mechanism 50 has a beveled end 58b. When front seat back 22 is rotated up to a certain point, the upper, front edge of catch 42 comes into contact with beveled end 58b. Beveled end 58b allows catch 42 during further upward rotation to push member 58 upwardly. Beveled end 58b is eventually moved upwardly enough to clear the top of catch 42, after which beveled end 58b moves into catch 42 for releasably locking front seat back 22 and curtain holder frame 40 in place. To fold or rotate front seat back 22 down to a collapsed position, the user is required to actuate or translate slidable button 52, compressing one or more spring 54, misaligning tabs 52t and 56t, and allowing the user to lift handle 56 through an opening 220 formed on the backside of front seat back 22, which in turn pulls beveled end 58b of member 58 out from the top of catch 42, allowing for the rotational movement of front seat back 22, hinges 44 and curtain holder frame 40.

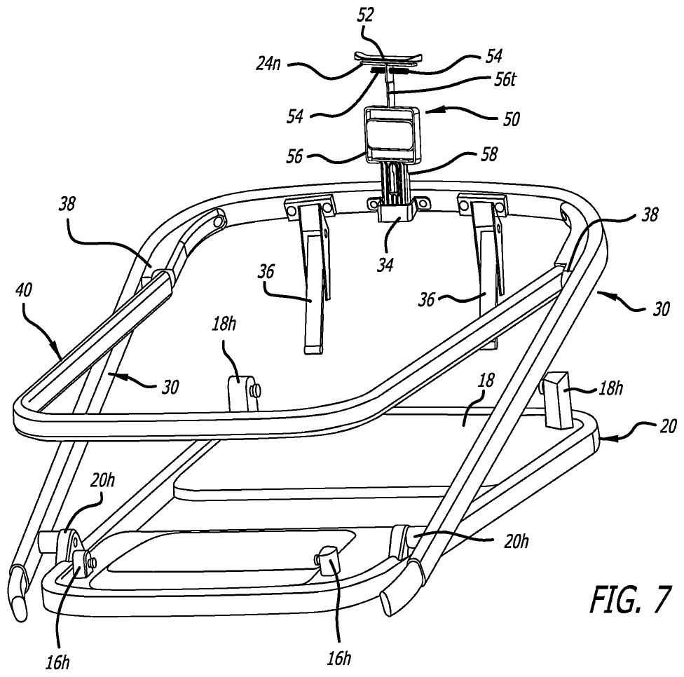

Similarly, FIG. 7 (rear seat back 24 removed for clarity) illustrates that catch 34 for securing rear seat back member 58 is provided by tubular lever 30 in one embodiment, so that when rear seat back member 58 is located within catch 34 of tubular lever 30, hinges 36 connecting rear seat back 24 (removed for clarity) to the tubular lever are locked and neither rear seat back 24 or tubular lever 30 can be rotated or collapsed.

FIG. 7 also illustrates that front and rear seat bottoms 16, 18 are in one embodiment attached to or otherwise supported by base frame 20. FIG. 7 also clearly shows lever hinges 20h fitted to or formed with base frame 20, which hingedly attach to tubular lever 30. FIG. 7 further clearly shows hinges 16h, 18h that extend upwardly from front and rear seat bottoms 16, respectively, and allow (i) front seat back 22 (removed for clarity) to connect rotatably to front seat bottom 16 and (ii) rear seat back 24 (removed for clarity) to connect rotatably to rear seat bottom 18. FIG. 7 still further clearly shows that curtain holder frame 40 is hinged to tubular lever 30 via hinges 38.

Release mechanism 50 including slidable button 52, one or more spring 54, handle 56 and member 58 are provided within and thus rotate with rear seat back 24. The user does not have to actuate slidable button 52 to rotate rear seat back 24 up from rear seat bottom 18. The user instead steps on lever foot pedal 32 (FIGS. 1 to 3) to open rear seat back 24 relative to rear seat bottom 18. But when rear seat back 24 is rotated fully up from rear seat bottom 18, member 58 again slides downwardly into catch 34 of tubular lever 30, locking rear seat back 24 and tubular lever 30 releasably in place. Viewing FIG. 7, when rear seat back 24 is in its collapsed position lying on top of rear seat bottom 18, tubular lever 30 is rotated down adjacent to base frame 20, and hinges 36 are rotated forward to essentially horizontal positions, allowing the rear end of tubular lever 30 to be spaced away from rear seat back 24. As rear seat back 24 is rotated up from rear seat bottom 18, hinges 36 rotate into increasingly more vertical positions as shown in FIG. 7, allowing the rear end of tubular lever 30 (having catch 34) to come increasingly closer to rear seat back 24.

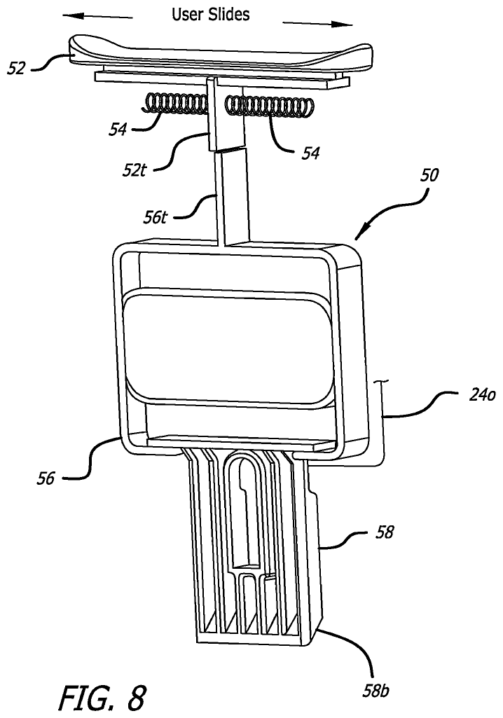

FIG. 8 illustrates that member 58 of release mechanism 50 likewise has a beveled end 58b. When rear seat back 24 is rotated up to a certain point (via the user actuating tubular lever 30), the upper, front edge of catch 34 comes into contact with beveled end 58b (as illustrated by the arrow). Beveled end 58b allows catch 34 during further upward rotation to push member 58 upwardly. Beveled end 58b is eventually moved upwardly enough to clear the top of catch 34, after which beveled end 58b moves into catch 34 for releasably locking rear seat back 24 and tubular lever 30 in place. To fold or rotate rear seat back 24 down to a collapsed position, the user is required to actuate or translate slidable button 52, compressing one or more spring 54, misaligning tabs 52t and 56t, and allowing the user to lift handle 56 through an opening 240 formed on the backside of rear seat back 24, which in turn pulls beveled end 58b of member 58 out from the top of catch 34, allowing for the rotational movement of rear seat back 24, hinges 36 and tubular lever 30.

Collapsible wagon 12 may be sized such that front or rear seat back 22, 24 rotates down and folds onto the other rear or front seat back. Here, there is a preferred order in collapsing seat backs 22, 24, where the seat back that rotates and folds onto the other seat back is collapsed second. Collapsible wagon 12 is sized alternatively such that front and rear seat backs 22, 24 do not interfere with one another when rotated down and folded onto their respective seat bottoms 16, 18. Here, front and rear seat backs 22, 24 may be collapsed in either order.

### Handle

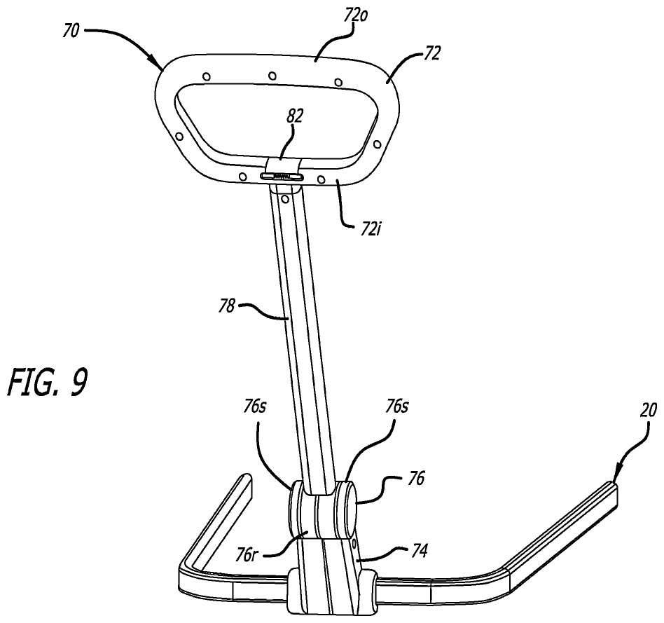

FIGS. 1, 2A, 9 and 10 illustrate that collapsible wagon 12 of the present disclosure also includes a handle 70 with which to pull, push, or otherwise move the wagon. As used herein, the term “handle” may include the entire handle mechanism extending from base frame 20 to a handle grip 72, which is grasped and maneuvered by the user. Handle 70 in the illustrated embodiment includes a handle extension 74, which may be molded or machined and be bolted or welded to base frame 20 (FIG. 9). Handle extension 74 extends to a handle pivot 76. The length of handle extension 74 is selected so that handle pivot 76 is located elevationally above front and rear seat backs 22, 24 when the backs are rotated and collapsed onto their respective seat bottoms 16, 18.

A handle shaft 78 extends from handle pivot 76 to handle grip 72, e.g., an enclosed or circular handle grip. The length of handle shaft 78 is selected so that overall handle 70 extends a desired distance from base frame 20. An outer portion 720 of handle grip 72 is grasped and pulled or pushed by the user to move collapsible wagon 12. An inner portion 72i of handle grip 72 includes an actuator or latch 82, which is part of a handle release mechanism 80. As described in detail below, handle release mechanism 80 enables handle shaft 78 and handle grip 72 to be locked in one of a plurality of rotational positions until the user desires to change the rotational position of the handle shaft.

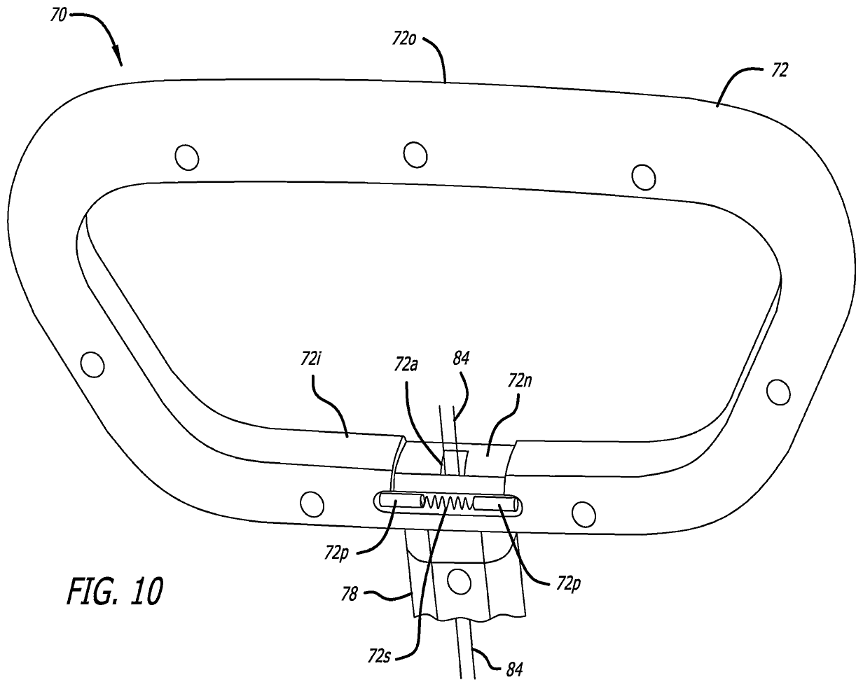

FIG. 10 with actuator latch 82 removed illustrates that the latch is in one embodiment pivotally connected to one or more pivot 72p located within a notch 72n formed in inner portion 72i of handle grip 72. Latch 82 is in one embodiment spring-biased closed via a spring, such as a spring 72s, which is held in place within notch 72n via one or more pivot 72p. Spring 72s may be fastened to the underside of latch 82 to bias the latch closed against notch 72n. It should be noted that the springs may be any type of spring, such as a compression spring, torsion spring, and/or any other spring as appropriate to the requirements of specific applications of embodiments of the invention. Notch 72n in the illustrated embodiment also defines an aperture 72a, though which one or more cable or wire 84 extends from the underside of pivoting latch 82 (to which one or more cable or wire 84 is/are attached), through handle shaft 78, to handle pivot 76.

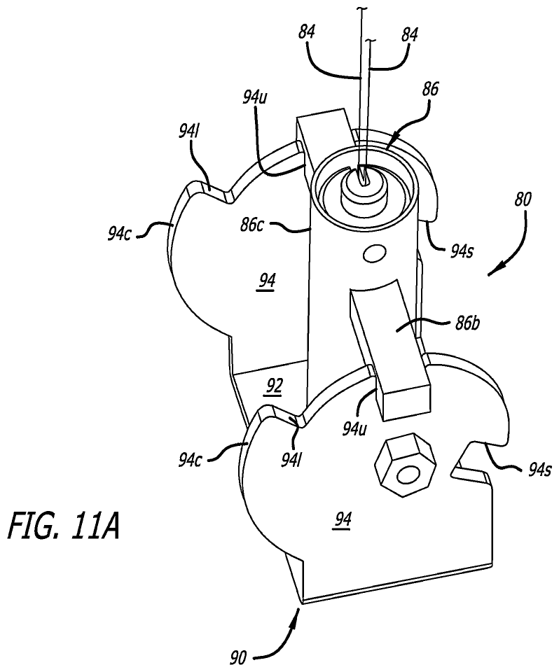

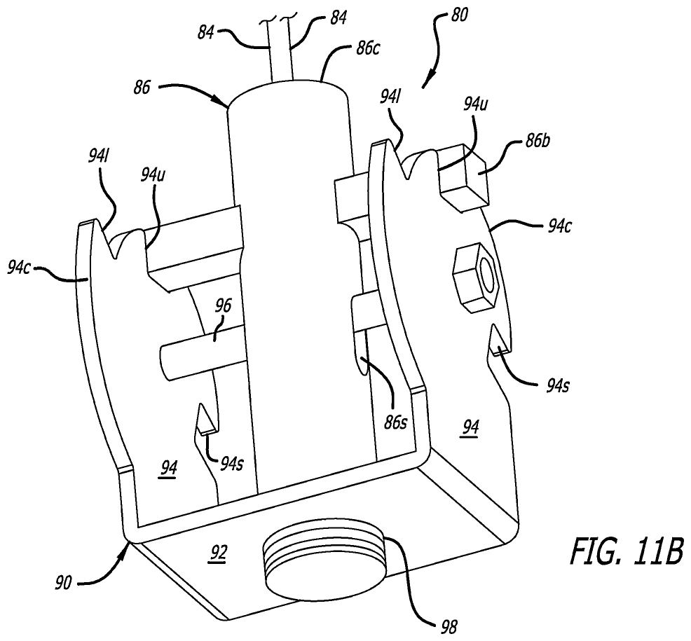

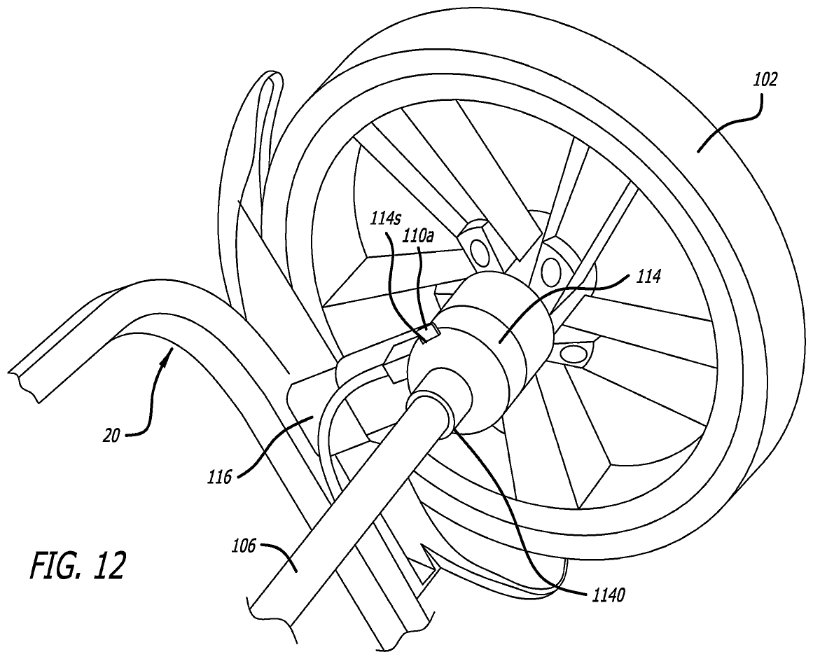

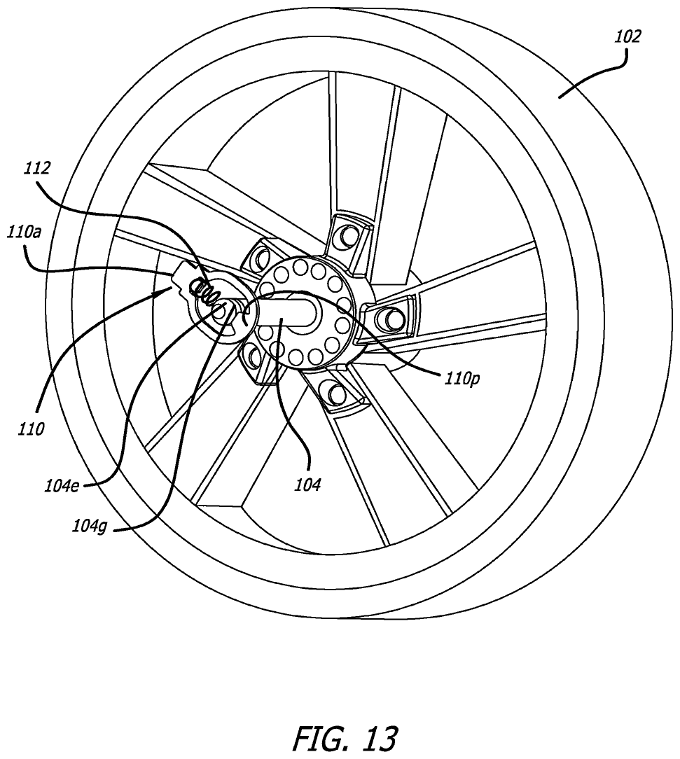

FIGS. 11A and 11B illustrate the portion of handle release mechanism 80 located within handle pivot 76. FIGS. 11A and 11B illustrate that one or more cable or wire 84 extends through handle shaft 78 to a translatable locking member 86, where the one or more cable or wire is/are attached. FIGS. 9, 11A and 11B illustrate that translating locking member 86 is part of a rotating (inner) portion 76r of handle pivot 76. In one embodiment, rotating portion 76r of handle pivot 76 is located within an outer non-rotating or stationary portion 76s of handle pivot 76, which may be formed with or attached to handle extension 74. The non-rotating or stationary portion 76s of handle pivot 76 may include housing covers (removed in FIGS. 11A and 11B) that hide a non-rotating bracket 90, wherein the bracket includes a bottom wall 92 and two end walls 94 extending from bottom wall 92. End walls 94 have the same shape in the illustrated embodiment. Each end wall 94 in an embodiment has an upper generally circular shape 94c. Notches 94s, 94u and 941 are formed in circular shapes 94c of the end walls 94, which define the different positions at which handle shaft 78 may be locked in place. Three notches 94s, 94u and 941 defining three different locked positions are provided in the illustrated embodiment, however, any desired number of locked positions may be defined using the notches of the present disclosure.

In one embodiment, the three different locked positions include a stowed position set by stowed position notch 94s, which is used when collapsible wagon 12 is collapsed or in its stowed position. A second position is an intermediate upright position set by upright position notch 94u, to which the user may conveniently bring handle shaft 78 and handle grip 72 when expanding wagon 12 from the collapsed position to the operable position. A third position set by travel limit notch 941 defines an end of travel limit that handle shaft 78 and handle grip 72 are allowed to rotate away from the rest of wagon 12 while the user is pushing or pulling the wagon. In one implementation, the notches 94s, 94u for the stowed and upright positions are three-sided, such that handle shaft 78 and handle grip 72 are constrained from moving in either direction in those positions. The third or travel limit position on the other hand may only have a generally two-sided notch 941, which constrains handle shaft 78 and handle grip 72 when reaching the end of travel during pulling and pushing, but which allows the user to adjust the handle shaft and handle grip between the upright position of notch 94u and the end of travel position as desired and at any time while pulling or pushing wagon 12. However, it should be noted that more or fewer handle positions can be utilized in accordance with aspects of the disclosure.

FIGS. 11A and 11B illustrate that translatable locking member 86 in one embodiment includes a cylindrical portion 86c that extends through a rotating hub of the rotating portion 76r of handle pivot 76. Translatable locking member 86 also includes a bar 86b that extends through or from cylindrical portion 86c of translatable locking member 86. Bar 86b and cylindrical portion 86c of translatable locking member 86 in the illustrated embodiment form a generally T-shaped structure. Bar 86b may be polygonal, such as square or rectangular, in cross-sectional shape. However, it should be noted that the bar may have any cross-sectional shape, such as an elliptical cross section, D-shaped cross section, and/or double D-shaped cross section, as appropriate to the requirements of specific applications of embodiments of the invention. In the illustrated embodiment, the cross-sectional shape of bar 86b matches and mates with the three-sided shapes of notches 94s, 94u formed in circular top portion 94c of each end wall 94 of bracket 90. Bar 86b engages corresponding ones of the plural notches 94s, 94u, 941 of each end wall 94 of bracket 90 to either releasably lock handle shaft 78 and handle grip 72 in a desired position, e.g., upright or stowed, or to catch the handle shaft and the handle grip at an end of travel for pulling or pushing collapsible wagon 12 of the present disclosure.

FIG. 11B further illustrates that bottom wall 92 of bracket 90 may define an opening 98, e.g., a circular hole, which is large enough to accept the bottom of the cylindrical portion 86c of translatable locking member 86. When handle shaft 78 and handle grip 72 are rotated to the second or intermediate upright position at notch 94u, the shaft and handle are perpendicular to bottom wall 92 of bracket 90. Additional room is needed to accept the length of travel of cylindrical portion 86c of translatable locking member 86. Opening 98 in bottom wall 92 of bracket 90 provides such additional room, allowing the bottom of cylindrical portion 86c to extend through bottom wall 92.

FIG. 11B also illustrates that cylindrical portion 86c of translatable locking member 86 includes or defines a slot 86s, which is sized to allow a pivot shaft 96 to extend through the slot. Slot 86s allows cylindrical portion 86c and bar 86b of translatable locking member 86 to rotate about pivot shaft 96. Slot 86s is sized also to allow cylindrical portion 86c to translate up and out of opening 98 for rotating to a new position and bar 86b to translate up and out of notches 94s, 94u for rotating to a new position.

In one embodiment, torsion spring 72s, which is fastened to the underside of latch 82 to bias the latch closed against notch 72n, serves a second purpose, namely, to be biased to maintain bar 86b in an engaged or locked position in one of plural notches 94s, 94u, 941 of each end wall 94 of bracket 90. When the user grasps and pulls the, e.g., pivotally connected, actuator or latch 82 (FIGS. 9, 10), the action causes torsion spring 72s to be uncoiled and one or more cable or wire 84 to be pulled, which in turn pulls translatable locking member 86, including perpendicularly disposed bar 86b, such that the bar is momentarily removed from the currently engaged notch 94s, 94u, 941 of each end wall 94 of bracket 90. The user is then able to rotate handle shaft 78 and handle grip 72 about handle pivot 76, such rotation being relative to handle extension 74, to a desired new locked position. For example, the user can rotate handle shaft 78 and handle grip 72 in the same direction from the stowed position at notch 94s to the upright position at notch 94u or to the end of travel position at notch 941. The user can rotate handle shaft 78 and handle grip 72 in either direction from the upright position to the stowed position or to the end of travel position. Or, the user can rotate handle shaft 78 and handle grip 72 from the end of travel position at notch 941 to the upright position at notch 94u.

To rotate handle shaft 78 and handle grip 72 to the stowed or collapsed position at notch 94s, front and rear seat backs 22, 24 first need to be rotated onto their respective front and rear seat bottoms 16, 18, as described above, so as to make room for the handle shaft and the handle grip. As discussed above, the user in one embodiment slides slidable buttons 52 at the top of front and rear seat backs 22, 24 to rotate the seat backs onto seat bottoms 16, 18, respectively. Because front seat back 22 is hingedly connected to curtain holder frame 40 and rear seat back 24 is hingedly connected to tubular lever 30, the folding down or collapsing of the front and rear seat backs 22, 24 also causes the accordion type relationship between curtain holder frame 40 and tubular lever 30 to collapse. Collapsible wagon 12 accordingly reaches a stowed or collapsed position. The user may now pull actuator latch 82 of handle release mechanism 80 and rotate handle shaft 78 and handle grip 72 into the stowed notch 94s position and onto the top of the folded-down or collapsed seat backs 22, 24.

To change collapsible wagon 12 from the collapsed position to the opened or operating position, the user first pulls latch 82 of handle release mechanism 80 and rotates handle shaft 78 and handle grip 72 from the top of the folded-down or collapsed seat backs 22, 24 to the upright position at notch 94u. The user then steps on lever foot pedal 32 formed with or connected to tubular lever 30. The user's stepping force causes tubular lever 30 to rotate about lever hinges 20h fitted to or formed with base frame 20. The hinged connection between rear seat back 24 and tubular lever 30 automatically causes the rear seat back to simultaneously rotate up from the rear seat bottom 18. Activation of slidable button 52 on the top of rear seat back 24 is not needed to rotate the rear seat back upwardly in one embodiment, however, the rear seat back's reaching of the fully opened position causes rear seat back 24 to be locked in the open position as discussed herein, which requires activation of slidable button 52 to again collapse rear set back 24. With rear seat back 24 opened, the user then grabs front seat back 22 and rotates it upward to the open position. Similarly, activation of slidable button 52 on the top of front seat back 22 is not needed to rotate front seat back 22 upwardly in one embodiment, however, the front seat back's reaching of the fully opened position causes front seat back 22 to be locked in the open position, which requires activation of slidable button 52 to again collapse front set back 22.

### Canopy Option

Collapsible wagon system 10 of the present disclosure may be provided with a canopy option. It is contemplated for wagon system 10 to connect the canopy in a plurality of different ways. In any case, FIGS. 1 to 4, and 25A illustrate that front and rear canopy holders 46, 48 are provided in one embodiment, which may be bent metal or formed plastic tubing forming U-shapes. The ends of the U-shapes of front and rear canopy holders 46, 48 connect respectively to front and rear seat backs 22, 24 (no hinging) or to curtain holder frame 40 (hinged connection). In one embodiment as illustrated in FIGS. 1 to 4, the ends of the U-shapes of the front and rear canopy holders 46, 48 connect respectively to front and rear seat backs 22, 24 in a non-hinged manner. Here, canopy holders 46, 48 ride with front and rear seat backs 22, 24 in changing from the opened or operating position to the stowed or collapsed position and vice versa.

In an alternative embodiment, the ends of the U-shapes of front and rear canopy holders 46, 48 connect respectively to curtain holder frame 40 in a hinged manner. FIG. 25A illustrates a collapsible wagon system 10 utilizing the canopy option. The canopy 250, e.g., cloth, is held on either end by the middle of the U-shapes of front and rear canopy holders 46, 48. The canopy 250 is slidable and removable from the canopy holders 46, 48. The canopy hinges 252) may include detents that maintain canopy holders 46, 48 in their upright positions. The force provided by the detents of the canopy hinges is relatively easily overcome by the user to fold down or collapse canopy holders 46, 48. When collapsing collapsible wagon 12 of the present disclosure, the collapsing or folding down of hinged canopy holders 46, 48 occurs immediately prior to the folding down or collapsing of the corresponding seat back 22, 24. When opening collapsible wagon 12 for operation, the opening of the hinged canopy holders 46, 48 occurs immediately after the opening of the corresponding seat back 22, 24. The canopy 250 may include inner pockets 256 as illustrated in FIG. 25B. The collapsible wagon 12 including the canopy 250 weighs approximately 41.80 pounds. The collapsible wagon 12 including the canopy 250, when open, measures approximately 1095 mm in length, 754 mm in width, and 1098 mm in height. The collapsible wagon 12 without the canopy 250, when open, measures approximately 1095 mm in length, 754 mm in width, and 1070 mm in height. The collapsible wagon 12, when folded, measures approximately 1056 mm in length, 754 mm in width, and 446 mm in height.

### Removable Wheels

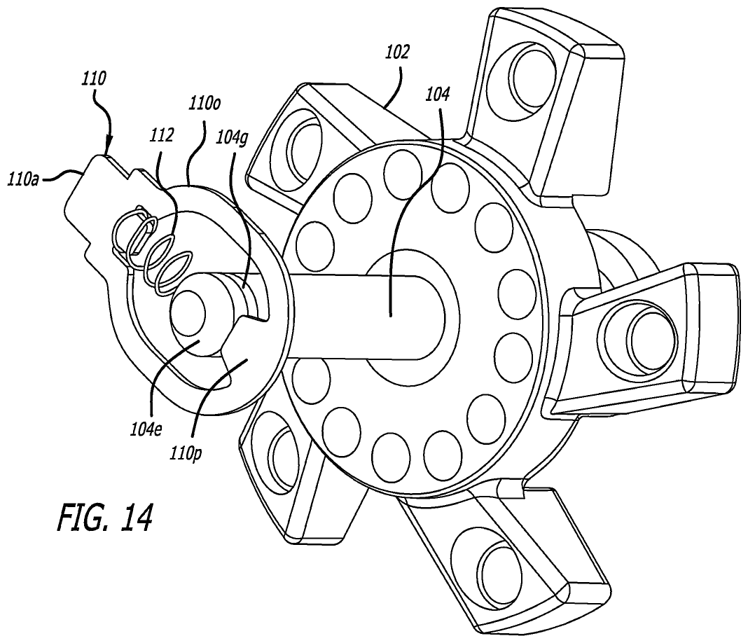

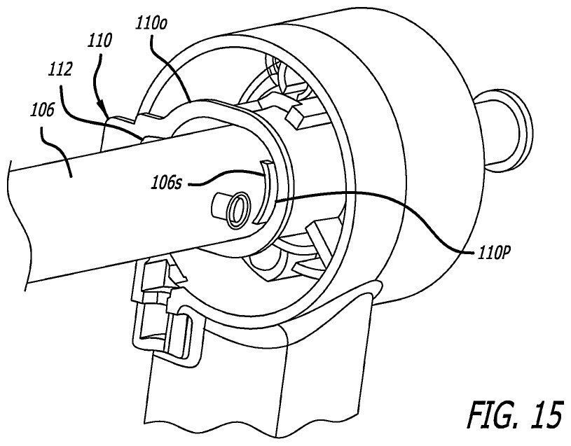

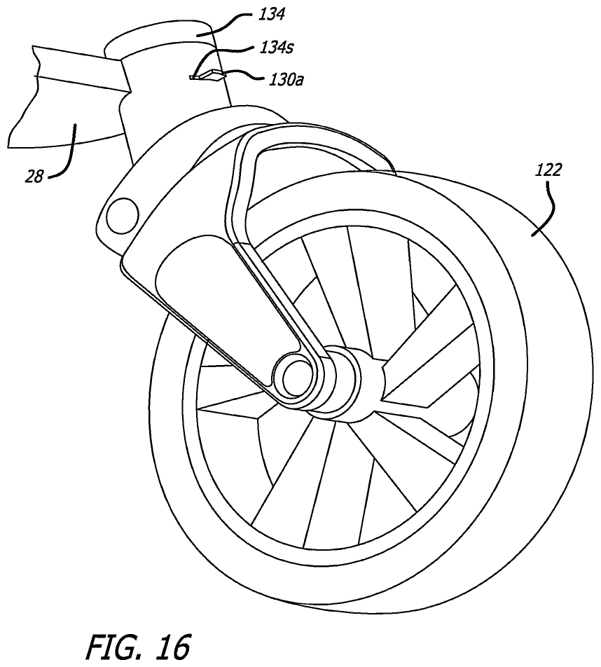

In an embodiment, rear wheels 102 and front wheels 122 of collapsible wagon 12 illustrated in FIGS. 1 and 2A are removable for replacement, cleaning, repair, etc. Rear wheels 102, which may, for example, be 12 inches in diameter, in an embodiment are removed laterally or sideways with respect to wagon 12, while front wheels 122, which may, for example, be 8 inches in diameter, are removed downwardly with respect to the wagon. Referring now to FIGS. 12 to 15 regarding rear wheels 102, the wheels are each fixedly connected to a rotating shaft 104 (FIGS. 13 and 14). Rotating shaft 104 fits inside of a tube 106 (FIGS. 12 and 15) that extends to both rear wheels 102 and is held fixed ultimately by the base frame 20. The end of rotating shaft 104 that fits inside of tube 106 defines an annular groove 104g extending all the way around the rotating shaft. The end 104e of rotating shaft 104 residing directly adjacent to annular groove 104g is beveled to aid in the reinsertion of rear wheel 102 and rotating shaft 104 into tube 106.

FIG. 15 illustrates that tube 106 in one embodiment defines a slot 106s, which may extend radially along the tube for, e.g., 20° to 50°. A user pressable tab 110 is provided, which has an O-shaped portion 1100 that fits around tube 106. O-shaped portion 110o includes or defines an engagement projection 110p that extends through slot 106s defined by tube 106. A spring 112 is located between tube 106 and the opposite end of O-shaped portion 1100 from engagement projection 110p. Spring 112 is biased to push tab 110 relative to tube 106 such that engagement projection 110p is forced through slot 106s in tube 106, and so that the end of engagement projection 110p becomes inserted into annular groove 104g defined by rotating shaft 104, which holds rear wheel 102 within tube 106 and rotatably fixed with respect to the rest of collapsible wagon 12. The annular nature of groove 104g of rotating shaft 104 dictates that the end of engagement projection 110p remains within the groove regardless of the rotational position of rear wheel 102 and rotating shaft 104 relative to tube 106.

Tab 110 also includes an actuation portion 110a located adjacent to O-shaped portion 1100. Actuation portion 110a extends through a slot 114s defined in a cover 114 (FIG. 12) having an opening 1140 through which tube 106 extends. A distal end of actuation portion 110a of tab 110 extends out from slot 114s formed in cover 114. In FIG. 12, cover 114 is held fixed to base frame 20 via leg 116. The distal end of actuation portion 110a is viewable and accessible by the user. When the user desires to disengage one of the rear wheels 102 from collapsible wagon 12, the user presses the distal end of actuation portion 110a of tab 110, translating O-shaped portion 1100 of the tab, which compresses spring 112 located between O-shaped portion 1100 and tube 106. Translating O-shaped portion 1100 of tab 110 also causes engagement projection 110p to momentarily come free from annular groove 104g of rotating shaft 104, which allows the user to pull rear wheel 102 and rotating shaft 104 in a sideways manner from tube 106 and the remainder of collapsible wagon 12.

After rear wheel 102 and rotating shaft 104 are removed and the user releases the distal end of actuation portion 110a of tab 110, spring 12 is also released so that it pushes engagement projection 110p of O-shaped portion 1100 of tab 110 back to the annular groove locking position, e.g., even further than the locking position, even though rotating shaft 104 defining annular groove 104g has been removed. As mentioned above, end 104e of rotating shaft 104 residing directly adjacent to annular groove 104g is beveled to aid in the reinsertion of rear wheel 102 and the rotating shaft into tube 106. Upon reinsertion of rear wheel 102 (or new rear wheel) and associated rotating shaft 104, the angled surface of beveled end 104e contacts engagement projection 110p of O-shaped portion 1100 of tab 110, pushing the projection outwardly along angled surface 104e, guiding the tab towards annular groove 104g. Eventually, engagement projection 110p reaches the end of angled surface 104e and moves along the constant diameter of rotating shaft 104 until snap-fitting into annular groove 104g. At that point, rear wheel 102 is again rotatably attached to the remainder of collapsible wagon 12.

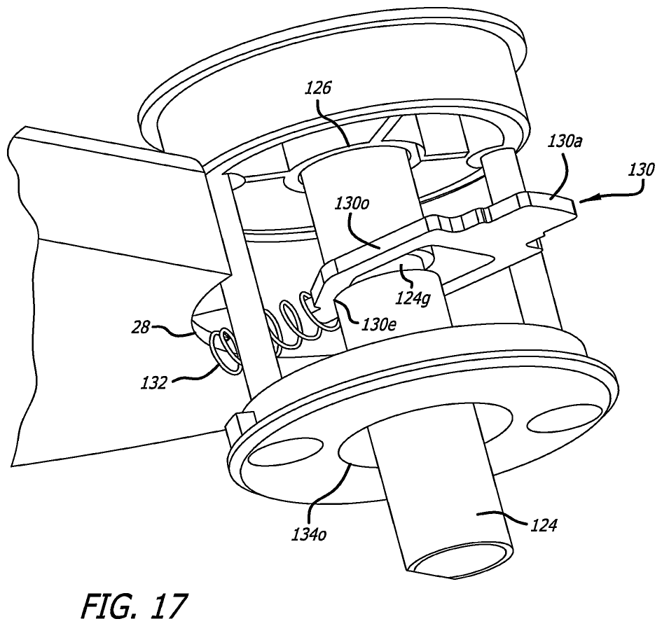

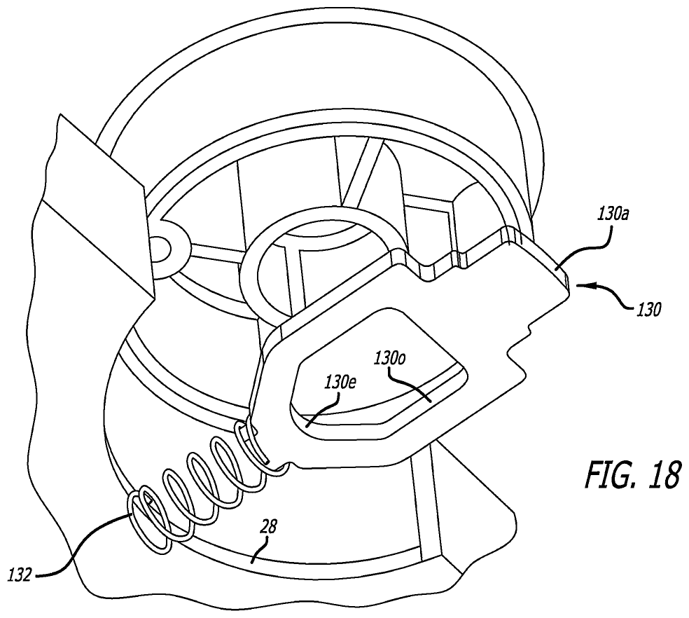

Referring now to FIGS. 16 to 19, disconnection and reconnection of front wheels 122 from and to collapsible wagon 12 involves a same or similar spring-loaded tab 130 (FIGS. 17 to 19), including an inner engagement edge 130e that fits into an annular groove 124g of a rotating shaft 124. Rotating shafts 124 of front wheels 122 are different than rotating shafts 104 of rear wheels 102. In the illustrated embodiment, rear wheels 102 do not swivel for steering wagon 12, while front wheels 122 do swivel. Rotating shaft 124 of front wheels 122 is in one embodiment the shaft allowing the front wheels to swivel, which extends generally upwardly instead of the horizontally extending rotating shafts 104 of rear wheels 102.

The upwardly extending rotating swivel shafts 124 of front wheels 122 extend into circular mounts 126, which are in one embodiment formed with or fastened to a bottom side of the front seat bottom 16. User pressable tabs 130 again include O-shaped portions 1300 that instead of fitting around tubes 106 for rear wheels 102, fit around rotating shafts 124. Another difference is that the O-shaped portions 1300 of tabs 130 for front wheels 122 do not include or define a projection that extends into annular groove 124g. Instead, inner engagement edge 130e of O-shaped portion 1300 extends into annular groove 124g. A further difference is that compression spring 132 is not located within the O-shaped portion as with rear wheels 102 and is instead located outside O-shaped 1300 portion of tab 130. The spring 132 for each front wheel 122 extends between the outside of the O-shaped portion 1300 of tab 130 and a plate 28 that extends along a front of base frame 20, from front wheel 122 to front wheel 122. Spring 132 is biased to push tab 130 relative to rotating shaft 124 such that inner engagement edge 130e of O-shaped portion 1300 extends into annular groove 124g defined by rotating shaft 124, which holds front wheel 122 within circular mount 126 and fixed relative to the rest of collapsible wagon 12. The annular nature of groove 124g of rotating shaft 124 again dictates that inner engagement edge 130e of O-shaped portion 1300 remains within annular groove 124g regardless of the rotational position of front wheel 122 and rotating shaft 124 relative to circular mount 126.

FIGS. 16 to 19 illustrate that tabs 130 of releasable front wheels 122 also include an actuation portion 130a located adjacent to O-shaped portion 1300. FIG. 17 illustrates that actuation portion 130a extends through a slot 134s defined in a cover 134 having an opening 1340 through which rotating shaft 124 extends. A distal end of actuation portion 130a of tab 130 extends out from slot 134s formed in cover 134. The distal end is viewable and accessible by the user. When the user desires to disengage one of the front wheels 122 from collapsible wagon 12, the user presses the distal end of actuation portion 130a of tab 130, translating the tab, which compresses spring 132 located between the O-shaped portion 1300 and plate 28. Translating tab 130 also causes inner engagement edge 130e of O-shaped portion 130o to momentarily come free from annular groove 124g of rotating shaft 124, which allows the user to pull front wheel 122 and rotating shaft 124 from circular mount 126 (here downwardly) and the remainder of collapsible wagon 12.

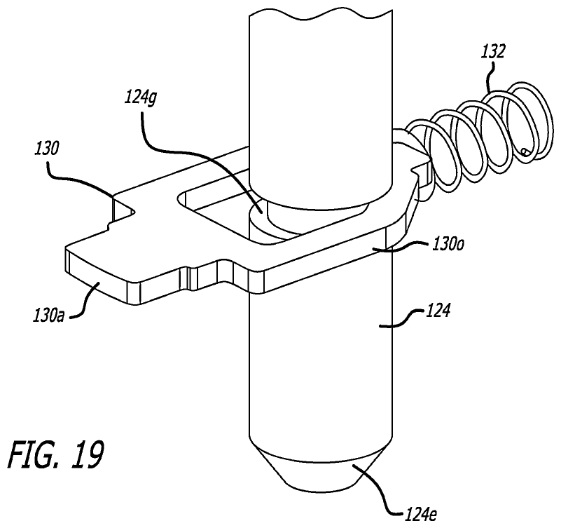

FIG. 19 illustrates that in one embodiment, the beveled ends 124e of rotating shafts 124 of front wheels 122 extend further from annular grooves 124g than with rotating shafts 104 of rear wheels 102. Nevertheless, the ends 124e of rotating shafts 124 of front wheels 122 are again beveled to aid in the reinsertion of front wheel 122 and rotating shaft 124 into circular mount 126. Upon reinsertion of front wheel 122 (or new front wheel) and associated rotating shaft 124, the angled surface of beveled end 124e contacts inner engagement edge 130e of O-shaped portion 1300 of tab 130, pushing the O-shaped portion 1300 outwardly along angled surface 124e, compressing spring 132. Eventually, O-shaped portion 1300 reaches the end of angled surface 124e and moves along the constant diameter of rotating shaft 124 until being snap-fitted via spring 132 into annular groove 124g. At that point, front wheel 122 is again rotatably attached to the remainder of collapsible wagon 12.

### Parking Brake

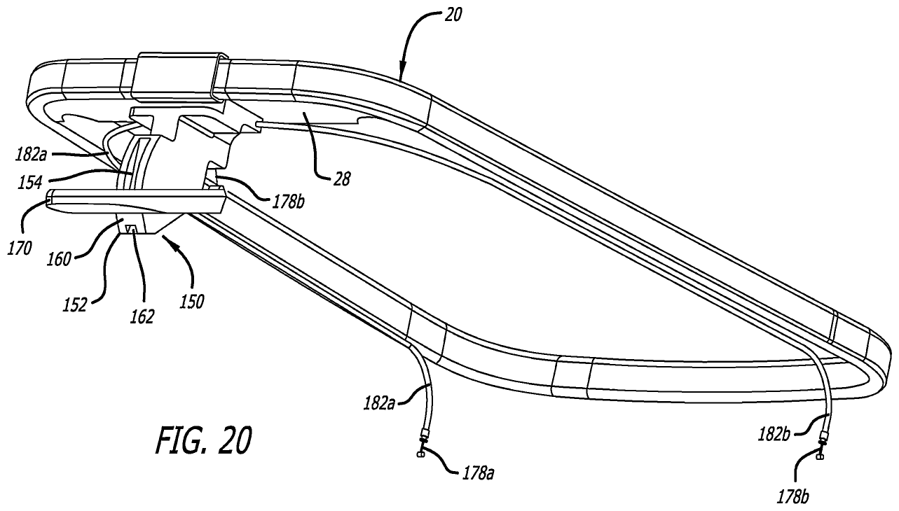

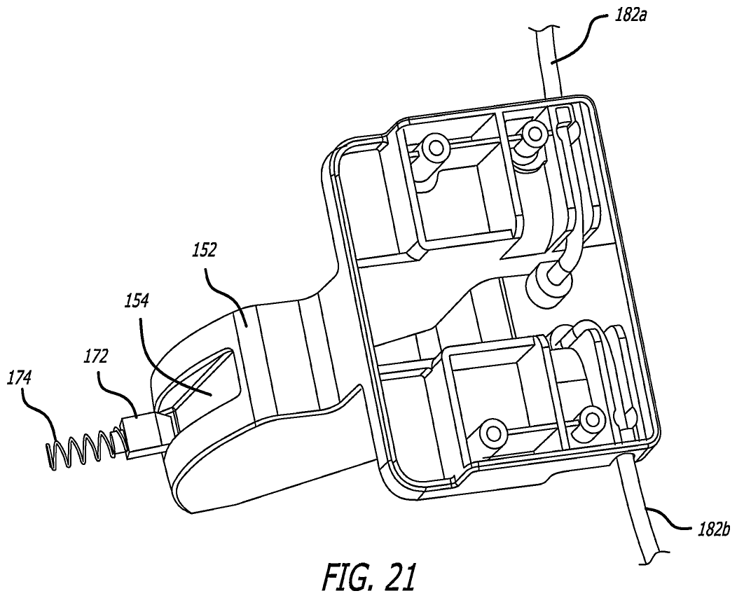

Referring now to FIGS. 20 to 24, collapsible wagon 12 of the present disclosure may further include a parking brake assembly 150. In a variety of embodiments, the parking brake assembly is shipped separately and assembled to the wagon by the user. Parking brake assembly 150 in an embodiment incudes a brake foot pedal 170, which is hingedly connected to a brake mount 152 allowing the user to rotatably lower and lift brake foot pedal 170 relative to brake mount 152 to engage and disengage, respectively, the braking of parking brake assembly 150. In an embodiment, brake mount 152 is formed with or is attached to plate 28 referenced above. FIG. 1 illustrates that brake foot pedal 170 is located beneath lever foot pedal 32 in one embodiment. FIG. 21 illustrates that brake mount 152 may form a groove 154 that sets the length and direction of the rotational travel of brake foot pedal 170 relative to the brake mount. Rotating brake foot pedal 170 moves a beveled head 172 of the foot pedal within groove 154 of brake mount 152. Beveled head 172 is in one embodiment spring-loaded via a compression spring 174 located within brake foot pedal 170.

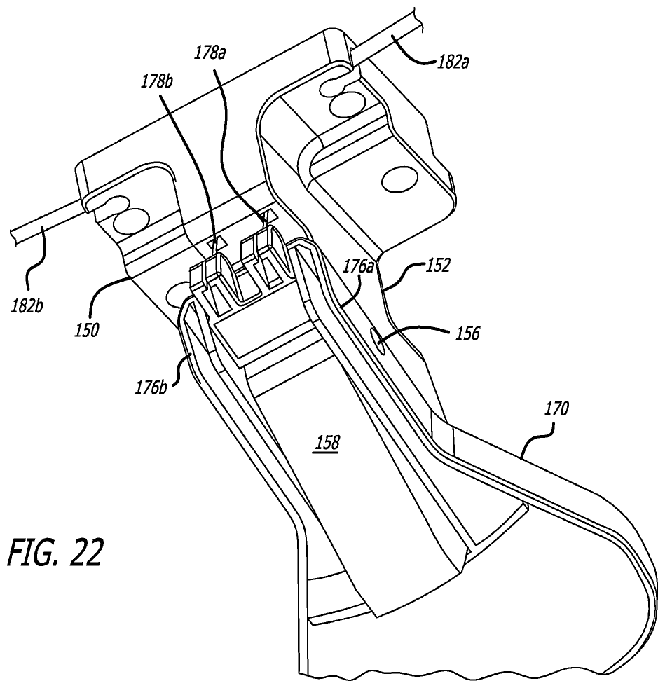

FIG. 22 illustrates that brake foot pedal 170 is in one embodiment hingedly connected to brake mount 152 via a hinge 156 that is inserted through a pair of arms 176a, 176b of brake foot pedal 170 that extend around the outside of a portion 158 of brake mount 152, through which hinge 156 also extends. An end of brake foot pedal 170 located on the opposing side of hinge 156 from where the user actuates foot pedal 170 is connected to the ends of a pair of cables or wires 178a, 178b. Each cable or wire 178a, 178b extends from the end 176 of brake foot pedal 170, through a respective protective tube 182a, 182b, along the bottom of collapsible wagon 12, e.g., generally following base frame 20, to each of the rear wheels 102.

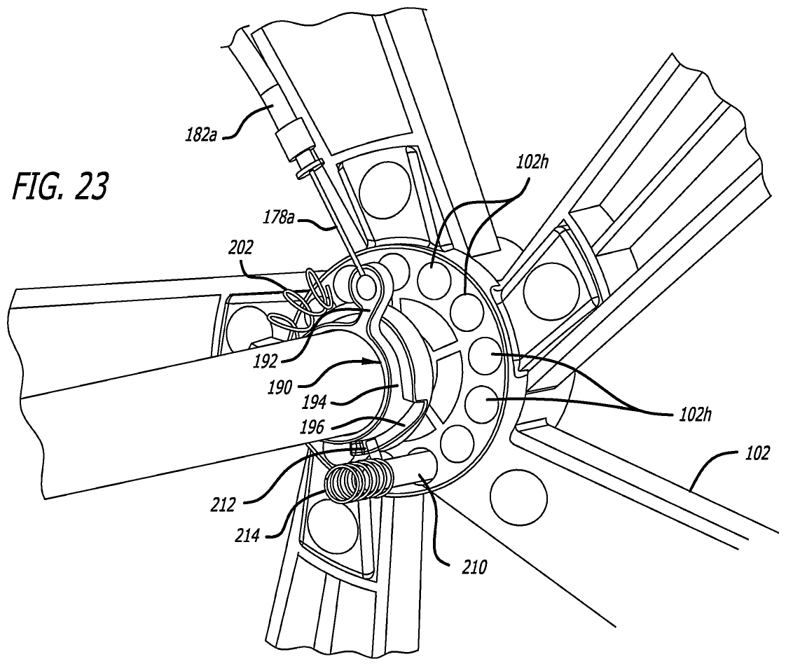

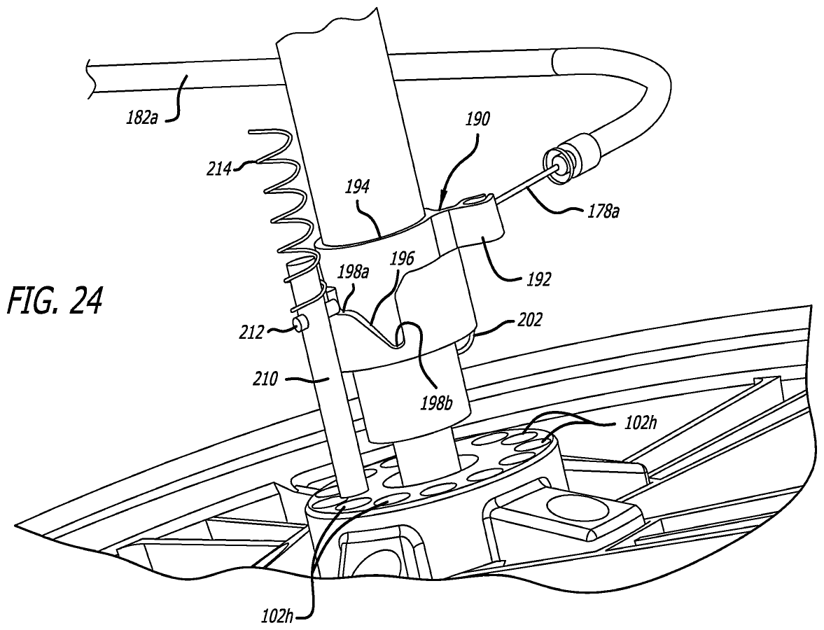

In an embodiment, the time that rear wheels 102 are about to be engaged by parking brake locking pins 210 (FIGS. 23 and 24) corresponds to the time at which a lower end of spring-loaded beveled head 172 reaches a bottom of groove 154 in brake mount 152 (see FIG. 21). The user is then forced to increase downward foot pressure on foot pedal 170 (providing tactile locking feedback to the user) so as to compress spring 174 to allow beveled head 172 to slide up over the bottom end of groove 154, slide over a portion 160 (FIG. 20) of an outer wall of brake mount 152 and into an adjacent opening 162 of the brake mount, wherein the opening is sized to hold beveled head 172 releasably fixed. Foot pedal 170 is now releasably locked in the parking brake engaged position, while rear wheels 102 have received parking brake locking pins 210 (FIGS. 23 and 24).

Rear wheels 102 remain locked until the user places their foot underneath foot pedal 170 and pushes up on the pedal. The user is required to supply enough force to foot pedal 170 (providing tactile unlocking feedback to the user) so as to again compress spring 174 to allow beveled head 172 to slide up over the top end of opening 162, slide over the same portion 160 of the outer wall of brake mount 152 and back into groove 154 via uncoiling pressure from the spring. Beveled head 172 being located back in groove 154 corresponds to the parking break locking pins 210 (FIGS. 23 and 24) having been removed from rear wheels 102. The user is now free to push or pull collapsible wagon 12 of the present disclosure.

FIGS. 23 and 24 illustrate that cable or wire 178a, 178b at rear wheels 102 is attached to an arm 192 extending off of a rotatable collar 190. A compression spring 202 is provided to maintain tension on cable or wire 178a and rotatable collar 190 and to maintain the rotatable collar in a parking brake unlocked or disengaged position. The hinged connection (FIG. 22) of brake foot pedal 170 to brake mount 152 dictates that the user pressing down on the foot pedal causes the opposite end of the foot pedal, which is connected to the cables or wires 178a, 178b, to rotate upwardly towards base frame 20, which in turn pushes the cables or wires simultaneously within their guiding tubes 182a, 182b, so that arm 192 and rotatable collar 190 located at the rear wheel end of the cables or wires are rotated against the force of spring 202 and into a parking brake locked or engaged position.

In the illustrated embodiment, rotatable collar 190 includes an inner cylindrical portion 194 and an outer cammed surface portion 196, which is also cylindrical. Parking break locking pin 210 is positioned adjacent to and generally in parallel with rotatable collar 190. Parking break locking pin 210 includes (e.g., is formed with or is inserted with) a cam follower pin 212, a portion of which is positioned so as to ride along the cammed surface portion 196 of rotatable collar 190 (FIG. 24). When compression spring 202 is maintaining tension on cable or wire 178a and rotatable collar 190 is rotated into in the parking brake unlocked or disengaged position, cam follower pin 212 is located along a section 198a of cammed surface 196 that prevents parking break locking pin 210 from entering one of a plurality of parking break receiving holes 102h. Additionally, a second compression spring 214 biased to push parking break locking pin 210 into one of the plurality of parking break receiving holes 102h is held in a compressed state.

When the user steps on parking break foot pedal 170 to cause cable or wire 178a to rotate rotatable collar 190 into in the parking brake locked or engaged position, cam follower pin 212 is in turn moved along cammed surface 196 to a section 198b of the cammed surface that allows parking break locking pin 210 to enter one of the plurality of parking break receiving holes 102h. Additionally, second compression spring 214 biased to push parking break locking pin 210 into one of the plurality of parking break receiving holes 102h is now allowed to expand and cause parking break locking pin 210 to enter one of parking break receiving holes 102h to releasably engage the parking brake assembly 150 of collapsible wagon 12 of the present disclosure. In an embodiment, the above-described locking or engaging procedure is performed on both rear wheels 102, e.g., simultaneously via the single user engagement or locking actuation of foot pedal 170.

Again, to release parking brake assembly 150, the user pushes up on the bottom of foot pedal 170 and the above-described procedure operates in reverse, wherein the hinged connection (FIG. 22) of brake foot pedal 170 to brake mount 152 dictates that the user pressing up on the foot pedal causes the opposite end of the foot pedal, which is connected to the cables or wires 178a, 178b, to rotate downwardly from base frame 20, which in turn pulls the cables or wires simultaneously within their guiding tubes 182a, 182b, so that arm 192 and rotatable collar 190 located at the rear wheel end of the cables or wires are rotated into a parking brake unlocked or disengaged position via the force of spring 202. That is, as soon as spring-loaded beveled head 172 reenters groove 154 formed in brake mount 152, spring 202 biased to maintain tension on cable or wire 178a is allowed to do so, rotating rotatable collar 190 into in the parking brake unlocked or disengaged position, wherein cam follower pin 212 is in turn rotated in the opposite direction along cammed surface 196 to the section 198a that removes parking break locking pin 210 from the engaged one of the plurality of parking break receiving holes 102h. Additionally, spring 214 biased to push parking break locking pin 210 into one of holes 102h is recompressed. In an embodiment, the above-described unlocking or disengaging procedure is performed on both rear wheels 102, e.g., simultaneously via the single user disengagement or unlocking actuation of foot pedal 170.

It should be understood that various changes and modifications to the presently preferred embodiments described herein will be apparent to those skilled in the art. It is therefore intended that such changes and modifications be covered by the appended claims. For example, tubular lever 30 does not have to be tubular and may instead be solid or have a structurally sound shape, such as an L-shape or T-shape. Also, parking brake assembly 150 may operate alternatively with a single wheel and/or with one or more front wheel 122.

### Rear Suspension

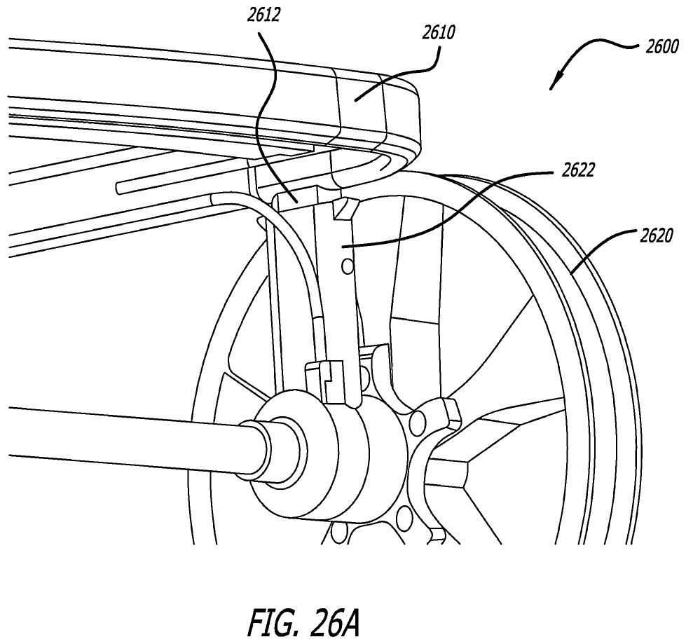

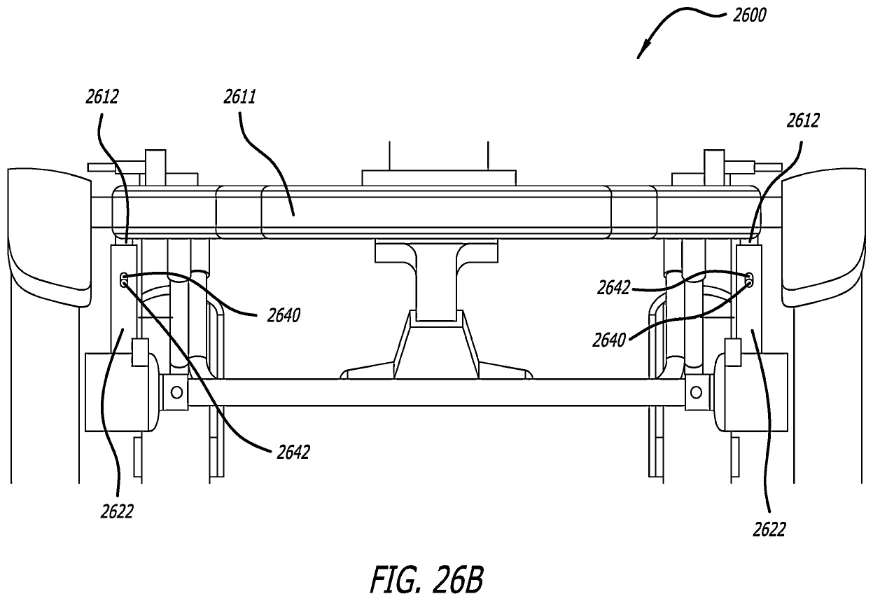

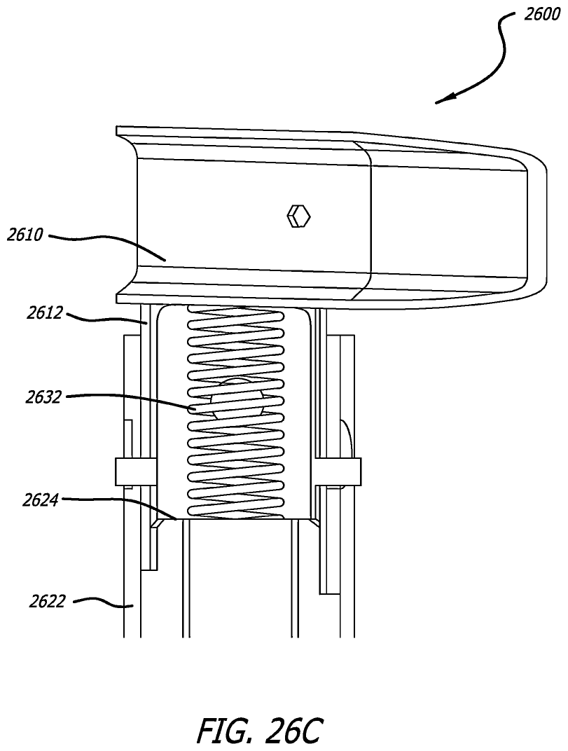

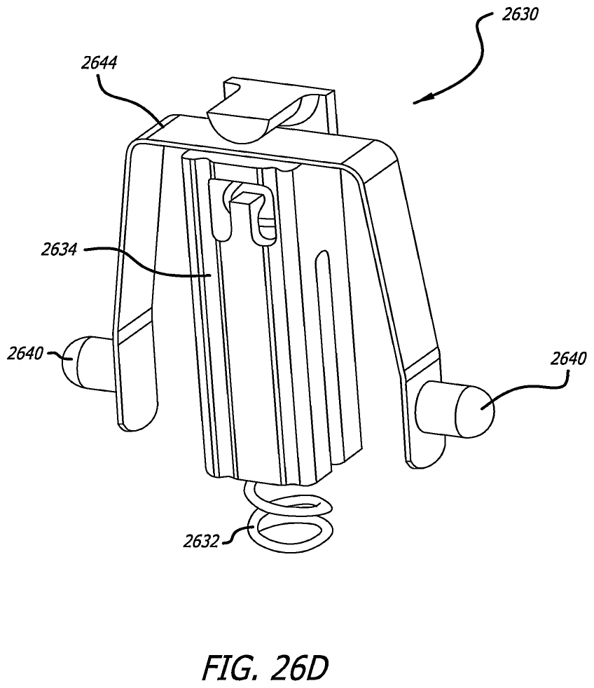

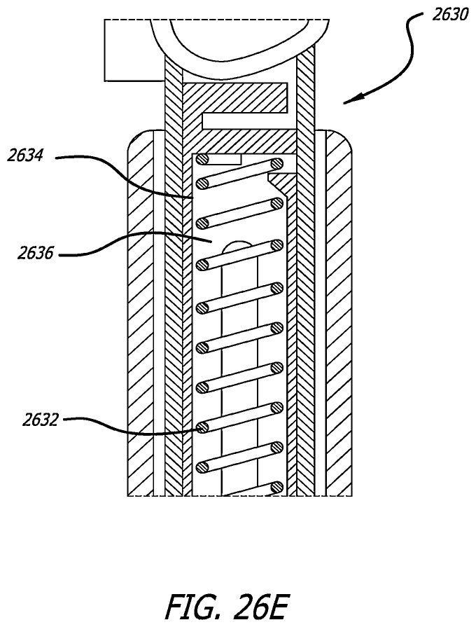

FIGS. 26A-E are conceptual illustrations of a rear wheel suspension system in accordance with a variety of embodiments of the present disclosure. The rear wheel system 2600 includes a rear wheel assembly having a rear wheel 2620 and a rear wheel frame 2612. The rear wheel frame 2622 engages with a lower member 2612 of a wagon frame member 2610. One or more suspension assemblies 2630 are located within the lower member 2612 and engages with a top portion 2624 of the rear wheel frame 2622. As shown in FIG. 26B, the rear wheel frame 2622 can define a travel limiter 2642 in which a stop 2640 travels. The stop 2640 can travel between a first end and a second end of the travel limiter 2642. In this way, the stop 2640 and travel limited 2642 can be used to define the travel distance for the suspension assembly 2630. The stop 2640 can be a separate element and/or formed into the suspension assembly 2630 (as shown in FIG. 26D) and/or formed into the lower member 2612 as appropriate to the requirements of specific applications of aspects of the disclosure. The suspension assembly 2630 can act as an independent suspension or a linked suspension for each of the rear wheels 2620.

As shown in FIG. 26C, the suspension assembly 2630 can include a spring 2632. However, it should be noted that the suspension assembly 2630 can include any suspension member or combination of suspension members that provides a dampening action, such as a shock or strut, in accordance with the requirements of specific applications of embodiments of the invention. The suspension member can be oriented along the direction of travel, perpendicular to the rotation of travel, and/or in any other orientation as appropriate to the requirements of specific applications of aspects of the disclosure. The suspension assembly 2630 allows the rear wheel frame 2622 to travel along the lower member 2612. In a variety of embodiments, the rear wheel frame 2622 travels in a linear motion. The suspension assembly 2630 can be coupled to the rear wheel frame 2622, the lower member 2612, and/or be a separate piece that is placed between the rear wheel frame 2622 and the lower member 2612 in accordance with the requirements of specific applications of embodiments of the invention.

As shown in FIG. 26D, the suspension assembly 2630 can include a suspension member 2632, a frame 2634, and a stop assembly 2644 having one or more stops 2640. The stop assembly 2644 of the suspension assembly 2630 is a separate element coupled to the frame 2634. However, it should be noted that the stops 2642 can be formed directly into the frame 2634. The suspension assembly 2630 is shown in cross section in FIG. 26E. As shown in the cross section, the frame 2634 defines a channel 2636 in which the suspension member 2632 can travel. In a variety of embodiments, the frame 2634 provides a cushion and/or guide to limit any interaction between the suspension member 1132 and the lower member 2612 and/or rear wheel frame 2622. In this way, the frame 2634 can prevent or limit noise and/or vibration from being created during the operation of the suspension assembly 2630.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, embodiments of the present disclosure should be considered in all respects as illustrative and not restrictive. It will be evident to the annotator skilled in the art to freely combine several or all of the embodiments discussed here as deemed suitable for a specific application of the disclosure. Throughout this disclosure, terms like “advantageous”, “exemplary” or “preferred” indicate elements or dimensions which are particularly suitable (but not essential) to the disclosure or an embodiment thereof, and may be modified wherever deemed suitable by the skilled annotator, except where expressly required. Accordingly, the scope of the invention should be determined not by the embodiments illustrated, but by the appended claims and their equivalents.

The invention is claimed as follows:

1. A collapsible wagon comprising:
a base frame;
a lever hingedly connected to the base frame adjacent to a first end of the wagon; and
a holder frame hingedly connected to the lever adjacent to a second end of the wagon;
wherein the lever includes a lever foot pedal positioned and arranged to enable a user to step on the lever foot pedal to hingedly open the lever relative to the base frame.

2. The collapsible wagon of claim 1, wherein at least one of the base frame, the lever or the holder frame is tubular.

3. The collapsible wagon of claim 1, wherein the holder frame is configured to hold at least one curtain forming at least one collapsible wall of the wagon.

4. The collapsible wagon of claim 1, wherein the second end of the wagon includes a second end seat back and a second end seat bottom, and which is configured such that the user stepping on the lever foot pedal causes the second end seat back to rotate away from the second end seat bottom.

5. The collapsible wagon of claim 4, wherein the second end seat back is hingedly connected to the lever, such that hingedly opening the lever relative to the base frame additionally rotates the second end seat back away from the second end seat bottom.

6. The collapsible wagon of claim 4, wherein the second end seat back is hingedly connected to the second end seat bottom.

7. The collapsible wagon of claim 4, which includes at least one hinge hingedly connecting the second end seat back to the lever, wherein the at least one hinge extends at least substantially horizontally when the second end seat back is rotated over the second end seat bottom, and wherein the at least one hinge extends at least substantially vertically when the second end seat back is rotated away from the second end seat bottom.

8. The collapsible wagon of claim 4, which includes at least one hinge hingedly connecting the second end seat back to the lever, wherein the at least one hinge extends at least substantially horizontally when the lever is in a collapsed positions, and wherein the at least one hinge extends at least substantially vertically when the lever is in an opened position.

9. The collapsible wagon of claim 4, which is configured such that the lever extends around an outside of the second end seat back when the lever is opened relative to the base frame.

10. The collapsible wagon of claim 4, wherein the first end of the wagon includes a first end seat back hingedly connected to a first end seat bottom.

11. The collapsible wagon of claim 1, wherein the first end of the wagon includes a first end seat back and a first end seat bottom, and which is configured such that the user opening the first end seat back from the first end seat bottom causes the holder frame to hinge open from the lever.

12. The collapsible wagon of claim 11, which is configured such that the holder frame hinging open from the lever causes at least a portion of a collapsible wall to open.

13. The collapsible wagon of claim 11, which includes at least one hinge hingedly connecting the first end seat back to the holder framer, wherein the at least one hinge extends at least substantially horizontally when the first end seat back is rotated over the first end seat bottom, and wherein the at least one hinge extends at least substantially vertically when the first end seat back is rotated away from the first end seat bottom.

14. The collapsible wagon of claim 11, which includes at least one hinge hingedly connecting the second end seat back to the lever, wherein the at least one hinge extends at least substantially horizontally when the lever is in a collapsed positions, and wherein the at least one hinge extends at least substantially vertically when the lever is in an opened position.

15. The collapsible wagon of claim 11, which is configured such that the holder frame extends around an outside of the first end seat back when the first end seat back is rotated away from the first end seat bottom.

16. A collapsible wagon comprising:
a base frame;
a lever hingedly connected to the base frame adjacent to a first end of the wagon; and
a seat back and a seat bottom located at an end of the wagon, and wherein the wagon is configured such that the user rotating the lever up from the base frame causes the seat back to rotate away from the seat bottom.

17. The collapsible wagon of claim 16, wherein the seat back is hingedly connected to the lever, such that rotating the lever up from the base frame additionally rotates the seat back away from the seat bottom.

18. The collapsible wagon of claim 16, wherein the seat back is hingedly connected to the seat bottom.

19. A collapsible wagon comprising:
a base frame;
a lever hingedly connected to the base frame adjacent to a first end of the wagon;
a holder frame hingedly connected to the lever adjacent to a second end of the wagon;
a second end seat back and a second end seat bottom located at the second end of the wagon, and wherein the wagon is configured such that the user rotating the lever up from the base frame causes the second end seat back to rotate away from the second end seat bottom; and
a first end seat back and a first end seat bottom located at the first end of the wagon, and wherein the wagon is configured such that the user opening the first end seat back from the first end seat bottom causes the holder frame to hinge open from the lever.

20. The collapsible wagon of claim 19, wherein the second end seat back is hingedly connected to the base frame, and wherein the first end seat back is hingedly connected to the holder frame.
